(19) United States
(12) Patent Application Publication
(10) Pub. No.: US 2014/0298112 A1
(43) Pub. Date: Oct. 2, 2014

(54) DETECTION METHOD, STORAGE MEDIUM, AND DETECTION DEVICE

(71) Applicant: FUJITSU LIMITED, Kawasaki-shi (JP)

(72) Inventors: Hiroshi Otsuka, Kawasaki (JP); YUKIHIRO WATANABE, Kawasaki (JP); YASUHIDE MATSUMOTO, Kawasaki (JP)

(73) Assignee: FUJITSU LIMITED, Kawasaki-shi (JP)

(21) Appl. No.: 14/224,780

(22) Filed: Mar. 25, 2014

(30) Foreign Application Priority Data
Mar. 29, 2013 (JP) 2013-074784

(51) Int. Cl. G06F 11/34

(52) U.S. Cl. CPC G06F 11/3452
USPC 714/47.3

(57) ABSTRACT

A detection method includes: calculating a statistic for each of Q configuration items, where Q is at least one, among a plurality of configuration items, according to a first frequency and a second frequency, when an occurrence of a failure of a certain type is predicted according to a first pattern, which is a combination of P messages output from the Q configuration items within a period not longer than a predetermined length of time, where P is not less than Q; and generating result information according to the statistic, the result information indicating at least one configuration item in which the failure of a certain type is predicted to occur with a probability that is at least higher than a probability with which the failure of a certain type is predicted to occur in another of the plurality of configuration items.

### CROSS-REFERENCE TO RELATED APPLICATION

This application is based upon and claims the benefit of priority of the prior Japanese Patent Application No. 2013-074784, filed on Mar. 29, 2013, the entire contents of which are incorporated herein by reference.

### FIELD

The embodiments discussed herein are related to a technology of managing a failure that has occurred in a computer system.

### BACKGROUND

Regarding failures that occur in a computer system, various studies have been conducted, for example, in regard to the following various aspects.
The way a point of failure or a cause of a failure is specified when a failure actually occurs.
How occurrences of failures are predicted.
How the burden on a person who addresses a failure, such as a system administrator, can be reduced.

For example, in a network system performance diagnosis method, network system design information and operation statistical information of network equipment are linked. In addition, design information and operation statistical information of different protocol layers, such as an IP (Internet Protocol) layer or an ATM (Asynchronous Transfer Mode) layer, are linked and integrally managed. Then, an occurrence range of a failure predictor and a point of cause are specified by displaying a list of operation statistical information along a route from a server to a client.

In some kinds of troubleshooting support technology for ascertaining and solving a cause of a trouble that has occurred in an information system, a performance information database is sometimes referred to. Further, an abnormal behavior detecting device, which aims at enabling detecting of an abnormal operation and specifying a cause thereof with respect to a behavior target in which a series of preceding behaviors may affect the subsequent behavior, has also been proposed.

In addition, an operation management device includes a correlation model generation unit and a correlation change analysing unit and the device aims at detecting a predictor of a failure and specifying an occurrence point of the failure. The correlation model generation unit derives at least a correlation function between first performance serial information, which indicates a time-series change in performance information on a first element, and second performance serial information, which indicates a time-series change in performance information on a second element. Each of the elements is a performance item or a managed device. The correlation model generation unit generates a correlation model according to the correlation function. Specifically, the correlation model generation unit obtains a correlation model for a combination of respective elements. The correlation change analysing unit analyzes a change in the correlation model according to performance information newly detected and obtained from the managed device.

In addition, in a failure analysis method, a failure point of a serious failure and a failure point of a minor failure, which is a predictor of the serious failure, are associated as one failure group, and are stored in a failure association table. Then, when a failure occurs, a failure type is determined from failure information, and the failure information is stored along with the failure type as failure log data. Further, when the failure occurs, the failure association table is referred to, a corresponding failure group number is specified, and the specified failure group number is stored while being associated with the failure log data. When a serious failure occurs, failure log data of a minor failure, which belongs to the same failure group as the serious failure, is referred to, and a failure detection point is specified.

Further, a management device has also been proposed that aims at appropriately making a failure detection according to a message pattern even when a configuration or setting of a device is changed. The management device includes determination means and update means.

Assume that, when a failure occurs in an information processing system, the number of times of detecting a first message pattern which indicates a message group including messages that are received from the information processing system during a given period, is stored in failure co-occurrence information. The determination means reads the number of detection times from the failure co-occurrence information, and calculates the co-occurrence probability of the failure and the first message pattern according to the number of detection times. When the co-occurrence probability is a threshold value or above, the determination means determines that the failure has occurred.

In addition, when a configuration element is changed, the update means generates a second message pattern which indicates a message group in which a message output from the changed configuration element is excluded from the first message pattern. Then, the update means updates the first message pattern, which is stored in the failure co-occurrence information, to the second message pattern.

In addition to the above, a program has been proposed that aims at reducing a workload for a failure detection in a computer system. Assume that, in a configuration information storage unit, type information of a configuration element of an information processing system is stored while being associated with identification information of the configuration element. A process that the program causes a computer to execute includes determining type information corresponding to a message that is output from the information processing system and includes the identification information, by using the configuration information storage unit. In addition, the process that the program causes the computer to execute includes collating a first message group and a second message group, which include a plurality of messages. Assume that the second message group is stored, specifically, in a message group storage unit, and that the type information of a configuration element of another information processing system is associated with each message included in the second message group. The process that the program causes the computer to execute further includes collating messages that do not match in the collation above, with regard to type information corresponding to the respective messages.

Documents, such as Japanese Laid-open Patent Publication No. 2002-99469, International Publication Pamphlet No. WO2010/010621, Japanese Laid-open Patent Publication No. 2005-141459, Japanese Laid-open Patent Publication No. 2009-199533, Japanese Laid-open Patent Publication No. 2009-230533, Japanese Laid-open Patent Publication No. 2012-123694, and Japanese Laid-open Patent Publication No. 2012-141802, are known.

### SUMMARY

According to an aspect of the embodiments, a detection method that is performed by a computer is provided.

The detection method includes calculating, by the computer, a statistic for each of Q configuration items, where Q is at least one, among a plurality of configuration items, according to a first frequency and a second frequency, when an occurrence of a failure of a certain type is predicted according to a first pattern, which is a combination of P messages output from the Q configuration items within a period not longer than a predetermined length of time, where P is not less than Q. The statistic relates to a probability that the failure of a certain type will occur in the individual configuration item in a future. Each of the plurality of configuration items is hardware, software, or a combination thereof included in a computer system. The first frequency indicates how many times a message of a same type as a type of an output message that is included in the P messages and that has been output from the individual configuration item has been output before a point in time of occurrence at which the failure of a certain type has formerly occurred. The second frequency indicates how many times the message of the same type as the type of the output message has been output within a window of time that extends for the predetermined length of time and ends at a point in time of output, at which a message has been output before the point in time of occurrence, and how many times an occurrence of the failure of a certain type has been predicted according to a second pattern, which is a combination of one or more messages included in the window period.

The detection method includes generating result information by the computer according to the statistic, the result information indicating at least one configuration item in which the failure of a certain type is predicted to occur with a probability that is at least higher than a probability with which the failure of a certain type is predicted to occur in another of the plurality of configuration items.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a flowchart of a process performed by a computer in a first embodiment.

FIG. 2 illustrates a hardware configuration of a computer.

FIG. 3 illustrates an example of a computer system.

FIG. 4 illustrates an operation of a detection server in a second embodiment.

FIG. 5 is a block diagram of the detection server in the second embodiment.

FIG. 6 illustrates examples of various tables used in the second embodiment.

FIG. 7 is a flowchart of a process performed by the detection server in the second embodiment.

FIG. 8 is a diagram explaining the learning of relation information in a third embodiment.

FIG. 9 is a diagram explaining the refinement of a ranking in the third embodiment.

FIG. 10 is a block diagram of a detection server in the third embodiment.

FIG. 11 illustrates examples of various tables used in the third embodiment.

FIG. 12 is a flowchart of a process by the detection server of learning the relation information in the third embodiment.

FIG. 13 is a flowchart (1) of a process by the detection server in the third embodiment of generating refined ranking information using the learnt relation information.

FIG. 14 is a flowchart (2) of the process by the detection server in the third embodiment of generating the refined ranking information using the learnt relation information.

### DESCRIPTION OF EMBODIMENTS

Preventing an occurrence of a failure in a computer system is useful for enhancing the availability of the computer system. However, a technology for preventing the occurrence of a failure is still developing, and has room for improvement.

As an example, with merely predicting whether a failure is likely to occur in a computer system, an object of preventing the occurrence of a failure is sometimes not attained satisfactorily. Specifically, when it is unclear which configuration item in the computer system it would be useful to take some measures against in order to prevent the occurrence of a failure, the object of preventing the occurrence of a failure is sometimes not attained satisfactorily.

In view of the foregoing, an aspect of the respective embodiments described below aims at detecting useful information for preventing the occurrence of a failure. According to the respective embodiments described below, useful information for preventing the occurrence of a failure is detected.

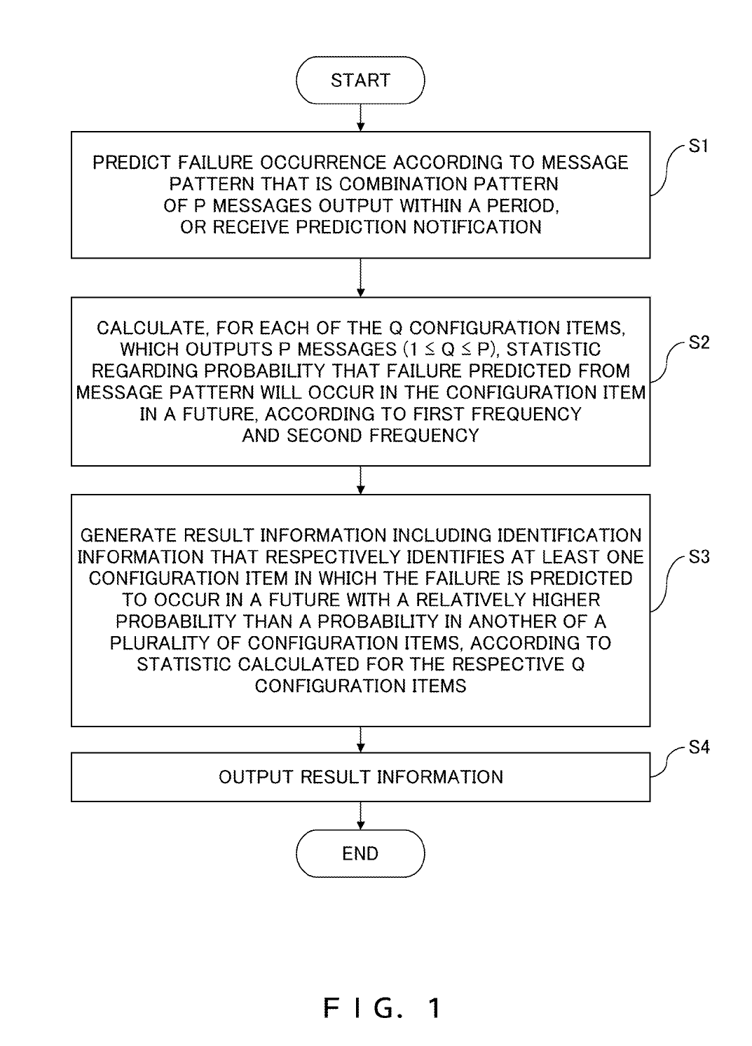

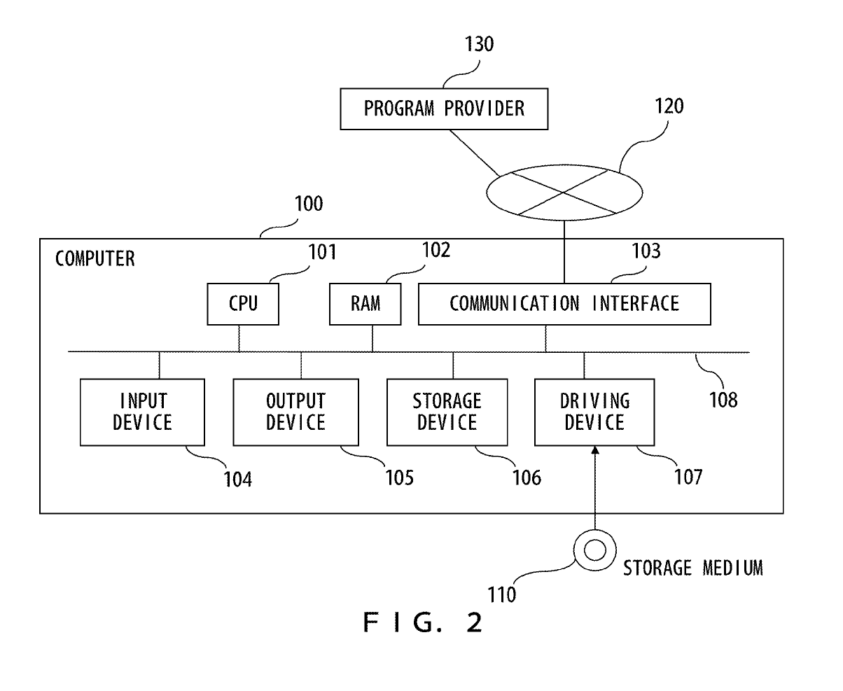

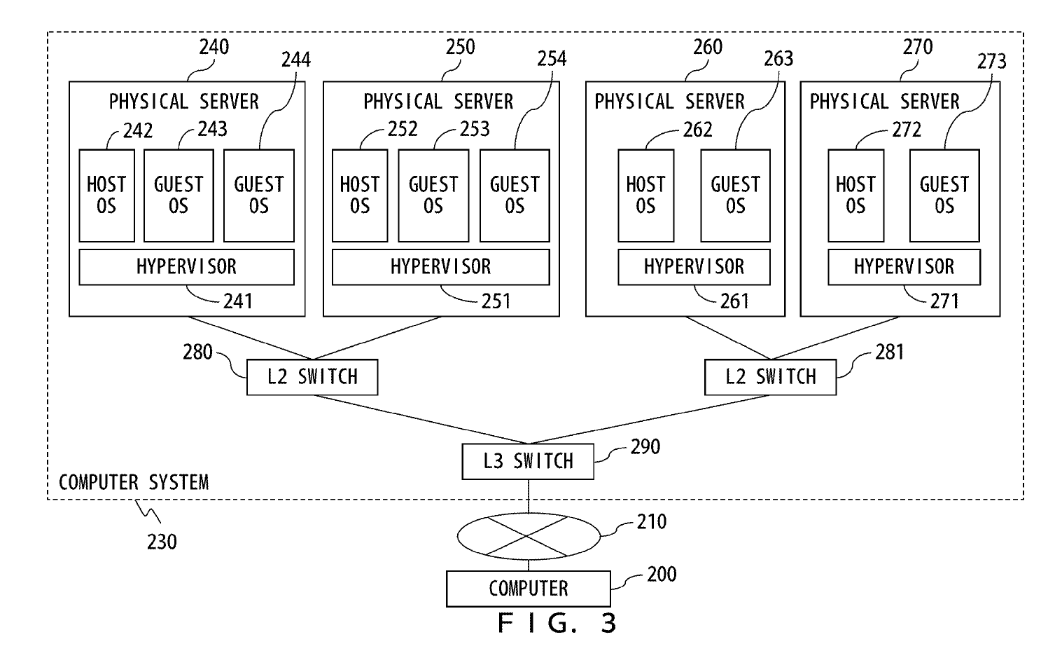

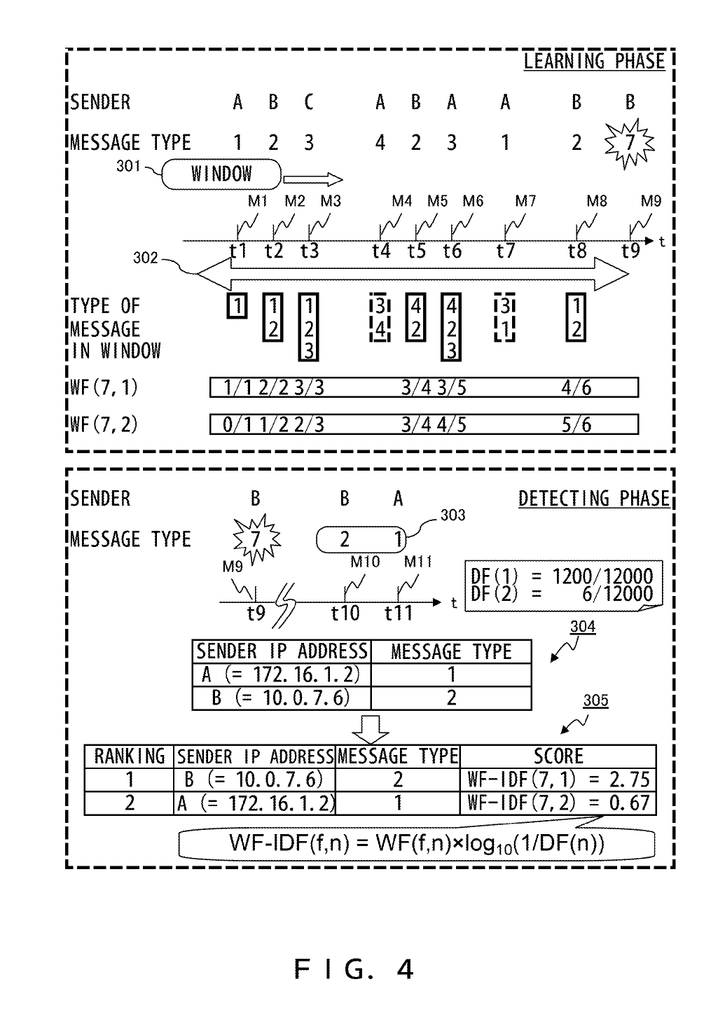

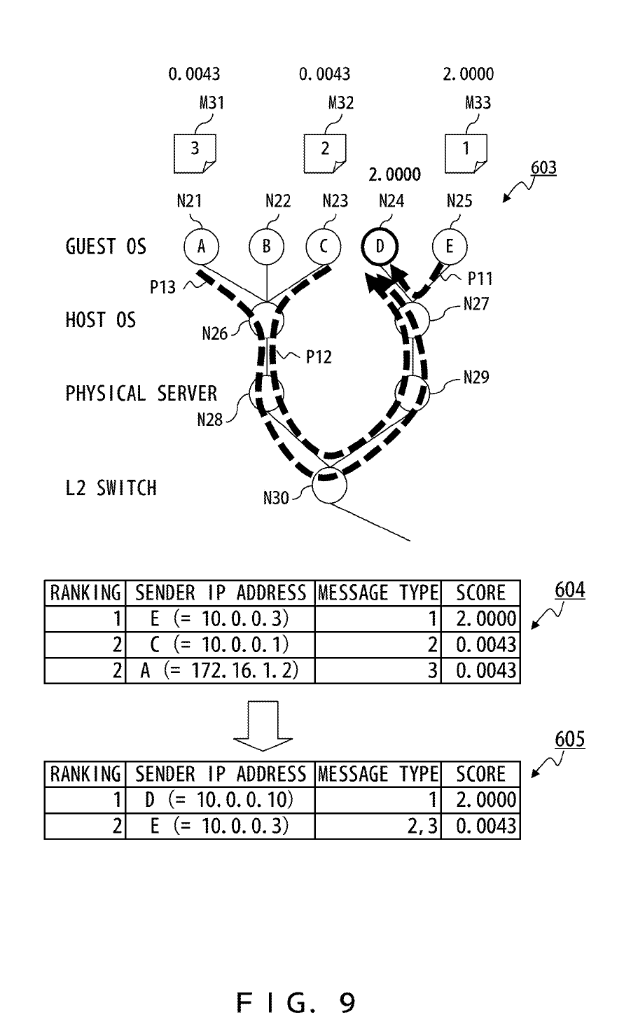

With reference to the drawings, the respective embodiments are described below in detail. Specifically, a first embodiment is described first with reference to FIG. 1, and points in common with first through third embodiments are described with reference to examples in FIGS. 2 and 3. Then, the second embodiment is described with reference to FIGS. 4-8, and the third embodiment is described with reference to FIGS. 9-13. Lastly, other variations are described.

FIG. 1 is a flowchart of a process performed by a computer in the first embodiment. The computer in the first embodiment manages a computer system.

The computer system includes a plurality of configuration items. The number of configuration items may vary. As an example, in a cloud environment, the number of configuration items is sometimes thousands to tens of thousands of orders.

Each of the configuration items is hardware or software, which is included in the computer system, or a combination thereof. For example, hardware devices, such as a physical server, an L2 (layer 2) switch, an L3 (layer 3) switch, a router, or a disk array device, are all examples of the configuration item. In addition, various pieces of software, such as an OS (Operating System), a middleware, or application software, are examples of the configuration item. Depending on the granularity of the configuration item, for example, a combination of a hardware device and software that runs on the hardware device may be regarded as one configuration item. For example, a configuration item may be a combination of a router and firmware that runs on the router.

Depending on the configuration of the computer system, a configuration item may be an OS running directly on a physical machine. Another configuration item may be an OS of a virtual machine that runs on a physical machine virtualized by a hypervisor. Of course, a virtualization technology other than the hypervisor may be used.

The virtual machine executed on the hypervisor is sometimes referred to as “a virtual machine”, “a domain”, “a logical domain”, “a partition”, or the like, according to an implementation. In addition, two or more virtual machines may be executed on the hypervisor, and according to the kind of implementation, a specified virtual machine will play a special role. The specified virtual machine is sometimes referred to as “a domain 0”, “a control domain”, or the like, and the other virtual machines are sometimes referred to as “a domain U”, “a guest domain”, or the like.

The OS on the specified virtual machine is sometimes referred to as “a control OS”, “a host OS”, or the like, and the OS on the other virtual machines is sometimes referred to as “a guest OS” or the like. As an example, according to the kind of implementation, the guest OS will sometimes access a device, such as a hard disk device, by using a function of a device driver of the host OS through the hypervisor.

Several technologies for detecting a predictor of a failure (namely, a sign of a failure) in the computer system have been proposed; however, merely detecting the predictor is sometimes insufficient for preventing an actual occurrence of a failure. Specifically, when it is unclear which configuration item in the computer system it would be useful to take measures against in order to prevent the occurrence of a failure, an object of preventing the occurrence of a failure is sometimes not attained satisfactorily. As an example, when it is unclear in which configuration item in a computer system a failure is likely to occur, it is also unclear which configuration item it would be useful to take measures against.

In view of the foregoing, the computer in the first embodiment generates and outputs information that suggests which configuration item in the computer system it would be useful to take measures against in order to prevent the occurrence of a failure, according to the flowchart of FIG. 1. Namely, in the first embodiment, useful information for preventing the occurrence of a failure can be detected.

First, in step S1, the computer predicts an occurrence of a failure of a certain type from among a plurality of types. In addition, in step S1, the computer receives a prediction notification which indicates that an occurrence of the failure of a certain type is predicted.

Specifically, when the computer itself performs a prediction, the computer predicts the occurrence of the failure of a certain type according to a first message pattern that is a combination pattern of P messages. In other words, the first message pattern is a first pattern that is a combination of P messages. Here, each of the P messages is a message that is output from any of Q configuration items from among the plurality of configuration items described above in the computer system (1≦Q≦P). Assume that the P messages are output during a period having a predetermined length of time or shorter (hereinafter referred to as a “first predetermined period”). Each of the P messages is specifically a message that reports an occurrence of an event.

The length of the first predetermined period may vary according to an embodiment. For example, the first predetermined period may be about one to five minutes, or may be shorter or longer.

As an example, assume that the first predetermined period is five minutes, the computer system includes 1000 configuration items, and in five minutes, 50 messages in all are output from 30 configuration items from among the 1000 configuration items. In this case, Q=30 and P=50. When Q<P as described above, at least one configuration item outputs two or more messages during the above period. Of course, some of the above 30 configuration items may output only one message during the above period.

In addition, the type of an event reported by each of the messages may vary. For example, various events, such as “a device was opened”, “an access to a web page was denied”, or “a physical server was rebooted”, are possible. A message reporting an event is sometimes referred to as an “event log”, a “message log”, or the like, or is sometimes simply referred to as a “log”.

The computer may learn co-occurrence information beforehand, such as “when one or more specific types of events occur during a period that does not exceed the first predetermined period, a specific type of failure is likely to occur”. The computer may predict the occurrence of the failure of a certain type according to the first message pattern (namely, the combination pattern of P messages) in step S1, according to the learnt co-occurrence information.

Alternatively, as described above, the computer may receive a prediction notification in step S1, instead of performing a prediction for itself. The prediction notification may be transmitted for example from another computer performing a prediction through a network. The prediction notification indicates specifically that the occurrence of the failure of a certain type is predicted from the first message pattern.

In any case, the computer can recognize that the first message pattern is a predictor of the failure of a certain type. However, as described above, merely detecting a predictor of a failure is insufficient.

Namely, when it is unclear which configuration item it would be useful to take measures against, a failure may fail to be prevented. On the other hand, preventing a failure is useful for attaining an effect of improving the availability of the computer system. In order to prevent the failure, it is useful to take appropriate measures. As an example of the measures, the exchange of hardware, the expansion of hardware, the rebooting of hardware or software, the upgrading of software, the reinstallation of software, or the like is considered.

The computer in the first embodiment further performs the processes of steps S2-S4 in order to present information indicating to a person, such as a system administrator, which configuration item it would be useful to take measures against. Namely, when the occurrence of the failure of a certain type is predicted according to the first pattern, the computer performs the processes of steps S2-S4.

In step S2, the computer calculates a statistic for each of the Q configuration items. The statistic calculated for a configuration item is, specifically, a value on a probability that the failure of a certain type, which is predicted from the first message pattern, will occur in the configuration item in the future.

The statistic does not need to be a value of the probability itself. For example, the statistic may be an optional value that increases with a higher probability.

The computer calculates the statistic according to, specifically, a first frequency and a second frequency as described below.

A point in time at which the predicted failure of a certain type actually occurred in the past is referred to as a “point in time of occurrence”. In addition, a message that is output from the configuration item for which the statistic is calculated, from among P messages, is referred to as an “output message”. Further, a frequency at which the same type of message as the output message has been output prior to the point in time of occurrence is referred to as a “first frequency”. The “frequency” may be a frequency in some kind of wide meaning, and therefore, concrete mathematical definitions of the first frequency may vary. Namely, various frequencies indicating how many messages of the same type as the output message have been output from a plurality of configuration items, which are included in the computer system, prior to the point in time of occurrence, may be used as the first frequency.

As an example, the first frequency may be a raw value itself of the frequency at which the same type of message as the output message has been output from any of the plurality of configuration items prior to the point in time of occurrence. Alternatively, a period that includes a point in time of the output of some kind of message (this message may be the same type of message as the output message or a different type of message from the output message) and goes back for the first predetermined period from the point in time, may be defined as a “window period”. The first frequency may be a value indicating how many times in all the same type of message as the output message has appeared during all of the window periods prior to the point in time of occurrence. Alternatively, the first frequency may be the number of window periods which include the same type of message as the output message, from among all of the window periods prior to the point in time of occurrence.

For example, there may be a case in which one message of the same type as the output message is included in three window periods, depending on a timing of the output of the message and a length of the first predetermined period. In this case, the first frequency may be incremented by 1 or 3, corresponding to the one message according to a concrete definition of the first frequency. In any case, the first frequency indicates how many messages of the same type as the output message have been output prior to the point in time of occurrence. In addition, the first frequency may be an absolute frequency or a relative frequency.

In a case in which two or more configuration items of the same type are included in one computer system, or in other cases, the two or more configuration items may output the same type of message. However, when a computer counts the first frequency, it does not matter from which configuration item the message has been output. The first frequency is a scale indicating how common a type of message the output message is, without any relationship with an occurrence of a failure. When the first frequency is high, the output message is a common type of message, whereas, when the first frequency is low, the output message is a rare type of message.

In addition, a point in time at which a message has been output prior to the point in time of occurrence described above (specifically, in the past within a second predetermined period from the point in time of occurrence) is referred to as a “point in time of output”. A period that includes the point in time of output and goes back for the first predetermined period from the point in time of output is referred to as a “window period”. In the past within the second predetermined period from the point in time of occurrence, two or more messages can be output. In such a case, a point in time of output and a window period are defined for each of the messages.

Either the first predetermined period or the second predetermined period may be longer, or both of them may have the same length. As an example, when the first predetermined period is five minutes and the second predetermined period is one hour, the window period is a period of five minutes, and this period ends at a point in time at which some type of message has been output in the past within one hour from the point in time of occurrence at which the failure of a certain type described above has actually occurred. The number of messages that has been output during the window period of five minutes may be one, or two or more. Hereinafter, a combination pattern of one or more messages which are included in the window period is referred to as a “second message pattern”. In other words, the second message pattern is a second pattern that is a combination of one or more messages included in the window period.

Further, a frequency at which the same type of message as the output message has been output from any of the plurality of configuration items during a window period and an occurrence of the failure of a certain type described above has been predicted according to the second message pattern, is referred to as a “second frequency”. The second frequency may have various concrete mathematic definitions. As an example, the second frequency may be an absolute frequency or a relative frequency.

In other words, “an occurrence of the failure of a certain type described above has been predicted according to the second message pattern” means “a prediction in the past according to the second message pattern is correct”. This is because the point in time of occurrence is a point in time at which the failure of a certain type described above has actually occurred in the past, and according to the definition above, points in time at which the respective messages in the second message pattern have been output are within the window periods prior to the point in time of occurrence.

Accordingly, under the conditions in which an occurrence of the failure of a certain type described above has been predicted according to the second message pattern, “the same type of message as the output message is output from any of the plurality of configuration items during a window period” means the following. Namely, this indicates that the same type of message as the output message is included in the second message pattern, which has been used as the basis for a correct prediction in the past.

Therefore, the second frequency indicates a frequency at which a prediction, which has been performed with respect to the failure of a certain type described above in the past by using, as a basis, the message pattern including the same type of message as the output message, is correct. According to an aspect, the second frequency is a scale that indicates how deeply the same type of message as the output message is associated with a correct predictor detection regarding the failure of a certain type described above.

The first message pattern and the second message pattern may be the same pattern coincidentally or be different patterns from each other. In other words, the same type of failure can be predicted according to two or more different patterns. Namely, there can be two or more predictors for one type of failure.

On the other hand, in two or more message patterns that are predictive of the same type of failure, a common type of message can be included. Therefore, according to an aspect, the second frequency is a scale that indicates how often the same type of message as the output message is included in message patterns that have respectively been used as the basis for one or more correct predictions in the past.

The calculation of a statistic in step S2 is performed according to the first frequency and the second frequency described above. A formula for deriving a statistic from the first frequency and the second frequency may be optionally defined according to an embodiment; however, it is preferable that the statistic be a value that monotonously decreases relative to the first frequency and monotonously increases relative to the second frequency.

This is because, when the statistic is defined as described above, a large value is calculated as a statistic for a configuration item which outputs a message which particularly co-occurs with the predicted failure of a certain type (but does not co-occur with the other types of failures). Namely, a large value is calculated as a statistic for a configuration item which outputs a specific type of message that characterizes the predicted failure of a certain type.

A statistic WF-IDF(f, n), which is used in second and third embodiments as described below, is an example of a statistic which monotonously decreases relative to the first frequency and monotonously increases relative to the second frequency.

The first frequency may be counted by a computer which performs the process in FIG. 1 or another computer. For example, the computer which performs the process in FIG. 1 may update a first count value, which is associated with the type of the message and is stored in a storage, every time a message is output from any of a plurality of configuration items included in a computer system. In this case, the computer may calculate the first frequency from the first count value.

Similarly, the second frequency may be counted by the computer which performs the process in FIG. 1. For example, the computer that performs the process in FIG. 1 may update a second count value, which is associated with two types of combinations described below and is stored in the storage, every time a failure of any type of the plurality of types actually occurs.
The type of each message included in the second message pattern that is the basis for the correct prediction of the occurring failure
The type of the occurring failure

For example, when four messages are included in the second message pattern and the types of the messages are different from each other, the computer respectively updates four second count values corresponding to the four messages. When the second count value is used as described above, the computer may calculate the second frequency from the second count value.

After the computer calculates the statistic for the respective Q configuration items in step S2 as described above, the computer performs a process of step S3. Specifically, the computer generates result information according to the statistic, which is calculated for the respective Q configuration items. The result information indicates one or more configuration items for which the failure of a certain type, which is predicted according to the first message pattern, is predicted to occur with a relatively high probability, from among a plurality of configuration items included in the computer system. Specifically, the result information includes identification information that respectively identifies the one or more configuration items.

The identification information may be, for example, an IP address or other information. For example, any one of the pieces of information described below or a combination of two or more pieces of information described below may be used for the identification information.
IP address
TCP (Transmission Control Protocol) port number
Host name
FQDN (Fully Qualified Domain Name) including a host name
MAC (Media Access Control) address
Application name
Identifier allocated to each configuration item in CMDB (Configuration Management Database)
Manufacturer’ serial number of a hardware device

In step S4, the computer outputs the result information. Specifically, the computer may for example display the result information on a display, output the result information as a sound from a microphone, or output the result information to a printer. In addition, the computer may generate an electronic mail or an instant message including the result information, and transmit the generated electronic mail or instant message to a system administrator. Of course, the computer may output the result information to a non-volatile storage. As described above, a specific method for the output in step S4 varies according to an embodiment. After the output in step S4, the process in FIG. 1 finishes.

It is preferable that the result information include identification information which identifies a configuration item having a maximum statistic from among the Q configuration items. This is because, according to an aspect, the configuration item having a maximum statistic is presumed to have a highest probability of an occurrence of a failure, and is presumed to be most important in the prediction of a failure. In some cases, taking some measures against the configuration item which is presumed to be important is useful for preventing the occurrence of the failure. An administrator, etc., may judge whether some measures are taken against the respective configuration items which are presumed to be important in the prediction of the failure, and take appropriate measures according to the judgment.

In some embodiments, in step S3, the computer may sort the Q configuration items according to a statistic and rank the Q configuration items according to the sorting result. Then, the computer may associate the respective pieces of identification information for all of the Q configuration items (or some configuration items having a relatively higher ranking among the Q configuration items) with a ranking and/or a statistic. The result information may be information including Q pieces (or less) of identification information, which are respectively associated with a ranking and/or a statistic as described above.

In addition, in step S3, the computer may estimate a probability that the failure of a certain type will occur in the future according to the respective statistics of the Q configuration items, with respect to some configuration items including configuration items other than the Q configuration items. Then, the computer may generate result information according to the estimation result in step S3.

For example, the computer may retrieve a relevant configuration item described below for the respective P messages. Specifically, the computer may retrieve the relevant configuration item using configuration information which indicates a relation between a plurality of configuration items included in a computer system.

Here, a configuration item which outputs a message which meets the two conditions described below is referred to as a “first configuration item”.
The same type of message as a message which the computer is currently focusing on as a message to be retrieved for the relevant configuration item, from among the P messages
A message which is included in the second message pattern, which has been used for the correct prediction in the past of the occurrence of the failure of a certain type

In addition, a configuration item in which the failure of a certain type which has been predicted correctly in the past has actually occurred is referred to as a “second configuration item”. Further, a relation between the first configuration item and the second configuration item is referred to as a “first relation”.

With respect to each of the P messages, the computer may retrieve a configuration item in which a second relation which is equivalent to the first relation holds true with a configuration item which has output the message, as a relevant configuration item. More specifically, the computer may retrieve the relevant configuration item as described above from among the plurality of configuration items included in the computer system by using the configuration information.

Note that the relation indicated by the configuration information may be any of the relation described below.
Logical dependency between two configuration items. For example, relation between a physical server and a host OS which runs on the physical server, relation between a host OS and a guest OS, etc.
Physical connection relation between two configuration items. For example, relation between a physical server and an L2 switch connected to the physical server, etc.
A composition of two or more logical dependencies. For example, a composition of logical dependency between a physical server and a host OS and logical dependency between the host OS and a guest OS (i.e., indirect logical dependency between the physical server and the guest OS), etc.
A composition of two or more physical connection relation. For example, a composition of physical connection relation between a physical server and an L2 switch and physical connection relation between the L2 switch and a router (i.e., indirect physical connection relation between the physical server and the router), etc.
A composition of one or more logical dependencies and one or more physical connection relation. For example, relation between a host OS and a storage device connected to a physical server on which the host OS runs, relation between two host OSs which respectively run on two physical servers connected to one L2 switch, etc.

When a relevant configuration item has been found with respect to a configuration item among the Q configuration items as a result of the retrieval using the configuration information as described above, the computer may perform the following process. Namely, the computer may determine an evaluation value on a probability that the failure of a certain type which is predicted according to the first message pattern will occur in the relevant configuration item in the future. The evaluation value for the relevant configuration item is determined on the basis of, specifically, a statistic which has been calculated in step S2 with respect to the configuration item in which the relevant configuration item has been found among the Q configuration items.

In some cases, two or more relevant configuration items have been found with respect to one configuration item among the Q configuration items. In other cases, the same configuration item has been found by chance for the respective relevant configuration items with respect to two or more configuration items among the Q configuration items. In any case, the computer reflects a statistic of a configuration item to an evaluation value of a relevant configuration item that has been found with respect to the configuration item.

By the process described above, an evaluation value may be determined with respect to the respective relevant configuration items that have been found as a result of the retrieval. In this case, the computer may generate the result information according to the evaluation value, which has been determined with respect to the respective relevant configuration items that have been found as a result of the retrieval.

For example, assume that, with respect to at least one of the Q configuration items, there are one or more configuration items that have been found as a relevant configuration item as a result of the retrieval from among a plurality of configuration items. In this case, the result information may include identification information which identifies a configuration item having a maximum evaluation value from among the one or more relevant configuration items. This is because, according to an aspect, the configuration item having a maximum evaluation value is presumed to have a highest probability of an occurrence of a failure, and is presumed to be most important in a failure prediction. Taking measures against the configuration item which is presumed to be most important in the failure prediction is sometimes useful for preventing the occurrence of the failure.

The computer may sort all of the configuration items for which an evaluation value has been determined (i.e., all of the relevant configuration items which have been found as a result of the retrieval) according to the evaluation value, or rank the configuration items according to the sorting result. Then, the computer may associate the respective pieces of identification information of all of the ranked configuration items (or, some configuration items having a higher ranking) with a ranking and/or an evaluation value. The result information may be information which includes some pieces of identification information which are respectively associated with a ranking and/or an evaluation value as described above.

No matter whether the retrieval using the configuration information and the determination of the evaluation value as described above are performed, the result information is generated according to Q statistics in step S3. Then, in step S4, the result information is output. Therefore, a person such as a system administrator can appropriately judge which configuration item the predicted failure is highly associated with by referring to the result information. The system administrator, etc., can also appropriately judge which configuration item it would be useful to take measures against in order to prevent an occurrence of a failure. The result information is information that assists the judgment. Further detailed examples for the retrieval using the configuration information and the determination of the evaluation value are described below along with the third embodiment.

FIG. 2 illustrates a hardware configuration of a computer. The computer which performs the process in FIG. 1 may be, specifically, a computer 100 in FIG. 2.

The computer 100 includes a CPU (Central Processing Unit) 101, a RAM (Random Access Memory) 102, and a communication interface 103. The computer 100 further includes an input device 104, an output device 105, a storage 106, and a driving device 107 of a computer-readable storage medium 110. These components of the computer 100 are connected to each other through a bus 108.

The CPU 101 is an example of a single-core or multi-core processor. The computer 100 may include a plurality of processors. The CPU 101 loads a program into the RAM 102 and executes a program while using the RAM 102 as a working area. For example, the CPU 101 may execute a program for the process in FIG. 1.

The communication interface 103 is, for example, a wire LAN (Local Area Network) interface, a wireless LAN interface, or a combination thereof. The computer 100 is connected to a network 120 through the communication interface 103.

The communication interface 103 may be, specifically, an external NIC (Network Interface Card) or an on-board type network interface controller. For example, the communication interface 103 may include a circuit referred to as a “PHY chip”, which processes a physical layer, and a circuit referred to as a “MAC chip”, which processes a MAC sub-layer.

The input device 104 is, for example, a keyboard, a pointing device, or a combination thereof. The pointing device may be, for example, a mouse, a touch pad, or a touch screen.

The output device 105 is a display, a speaker, or a combination thereof. The display may be a touch screen.

The storage 106 is, specifically, one or more non-volatile storages. The storage 106 may be, for example, an HDD (Hard Disk Drive), an SSD (Solid-State Drive), or a combination thereof. Further, a ROM (Read Only Memory) may be included as the storage 106.

The storage medium 110 is, for example, an optical disk, such as a CD (Compact Disc) or a DVD (Digital Versatile Disk), a magneto-optical disk, a magnetic disk, or a semiconductor memory card, such as a flash memory.

The program executed by the CPU 101 may be installed beforehand in the storage 106. The program may be stored to the storage medium 110, be provided, be read from the storage medium 110 by the driving device 107, and be copied to the storage 106, and then be loaded into the RAM 102. Alternatively, the program may be downloaded and installed from a program provider 130 on the network 120 through the network 120 and the communication interface 103 to the computer 100. The program provider 130 is, specifically, another computer.

The RAM 102, the storage 106, and the storage medium 110 are respectively a computer-readable tangible medium, not a transitory medium, such as a signal carrier wave.

The computer 100 in FIG. 2 may be connected to the computer system described with respect to FIG. 1 through the network 120.

The computer 100 may receive a message from an optional configuration item that is included in the computer system through the network 120 and the communication interface 103, and store the received message in the storage 106. Alternatively, each of the messages output from the configuration item may be stored in a storage of another computer not illustrated, along with identification information (e.g., an IP address) of the configuration item, which has output the message. The computer 100 may access the storage through the network 120 and the communication interface 103, and read the stored message.

In any case, the computer 100 can obtain the P messages described with respect to step S1 of FIG. 1. Therefore, the computer (more specifically, the CPU 101) can predict the occurrence of the failure of a certain type from the P messages.

Alternatively, an embodiment in which the computer 100 does not obtain the P messages is possible. Namely, the computer 100 may receive a prediction notification indicating the prediction of the occurrence of the failure of a certain type through the network 120 and the communication interface 103 in step S1. In this case, the prediction notification includes information (for example, P IP addresses) which indicates which configuration item the respective P messages have been output from.

Therefore, no matter whether the computer 100 performs a prediction in step S1, or receives a prediction notification, the computer 100 can also recognize configuration items which have output the respective messages.

As described with respect to step S2 of FIG. 1, the first frequency may be counted by the computer 100 (more specifically, the CPU 101). In this case, the first frequency (or the first count value used for the calculation thereof) is stored in the storage 106 or the RAM 102. Alternatively, the first frequency may be counted by another computer. In this case, the computer 100 may obtain the first frequency through the network 120 and the communication interface 103.

Similarly, the second frequency may be counted by the CPU 101, or be obtained through the network 120 and the communication interface 103. Namely, the second frequency (or the second count value used for the calculation thereof) may also be stored in the storage 106 or the RAM 102.

In any case, the computer 100 (more specifically, the CPU 101) can recognize the first message pattern, which is a combination pattern of the P messages, the first frequency, and the second frequency. The computer 100 can also recognize which configuration item each of the P messages has been output from. Accordingly, the computer 100 can calculate a statistic for each of the Q configuration items in step S2.

Further, the computer 100 can also generate result information using the calculated Q statistics in step S3. When the computer 100 uses configuration information for the generation of the result information, the configuration information may be stored in the storage 106 of the computer 100. Alternatively, the configuration information may be stored in the storage which is connected to the computer 100 through the network 120.

In step S4, the computer 100 may output the result information to the output device 105, to the storage 106, or to the storage medium 110 through the driving device 107. The computer 100 may output the result information to another device connected through the network 120 (e.g., another computer, a network storage device, or a printer). The computer 100 may generate an electronic mail or an instant message including the result information, and transmit the generated electronic mail or instant message through the communication interface 103 and the network 120.

As described above, the process in FIG. 1 may be performed by the computer 100 illustrated in FIG. 2.

FIG. 3 is a diagram that illustrates an example of a computer system. FIG. 3 illustrates a computer 200, a network 210 to which the computer 200 is connected, and a computer system 230 which is connected to the network 210. The computer 200 is specifically a computer which performs the process in FIG. 1. The computer 200 may be the computer 100 illustrated in FIG. 2, and in this case, the network 210 is the network 120 illustrated in FIG. 2.

A computer system 230 includes four physical servers, two L2 switches, and one L3 switch. Specifically, in the example illustrated in FIG. 3, physical servers 240 and 250 are connected to an L2 switch 280, physical servers 260 and 270 are connected to an L2 switch 281, and the L2 switches 280 and 281 are connected to an L3 switch 290. The L3 switch 290 is connected to the network 210.

A physical server 240 is virtualized by a hypervisor 241. Specifically, a host OS 242, a guest OS 243, and a guest OS 244 run on the hypervisor 241.

Similarly, a physical server 250 is virtualized by a hypervisor 251. Specifically, a host OS 252, a guest OS 253, and a guest OS 254 run on the hypervisor 251.

Similarly, a physical server 260 is virtualized by a hypervisor 261. Specifically, a host OS 262 and a guest OS 263 run on the hypervisor 261.

Similarly, a physical server 270 is virtualized by a hypervisor 271. Specifically, a host OS 272 and a guest OS 273 run on the hypervisor 271.

For example, pieces of hardware and software described below are examples of configuration items which are included in the computer system 230.
Each of the physical servers 240, 250, 260, and 270
Each of the L2 switches 280 and 281
The L3 switch 290
Each of the hypervisors 241, 251, 261, and 271
Each of the host OSs 242, 252, 262, and 272
Each of the guest OSs 243, 244, 253, 254, 263, and 273
Each application not illustrated which runs on the guest OS.

The granularity of the configuration item may vary according to an embodiment. The identification information which identifies each of the configuration items may be any kind of information that can identify each of the configuration items. The examples of the identification information are as described above.

According to a granularity of the configuration information, a set of some pieces of hardware, a set of some pieces of software, or a set of one or more pieces of hardware and one or more pieces of software may be treated as one configuration item. For example, when an IP address is used for identification information, the entirety of a set including a guest OS and a plurality of applications may be treated as one configuration item. This is because the guest OS and the plurality of applications on the guest OS transmit a message from the same IP address.

A protocol which is used for the transmission of a message by each of the configuration items may vary according to an embodiment. A different protocol may be used according to the type of the configuration item. An example of the protocol used for the transmission of the message is an ICMP (Internet Control Message Protocol), an SNMP (Simple Network Management Protocol), or the like. Of course, another protocol may be used.

In the first embodiment described above, when an occurrence of a failure of a certain type is predicted, result information is generated and output. The output result information indicates a configuration item having a high probability of the predicted occurrence of the failure. Accordingly, the result information suggests which configuration item it would be useful to take measures against. Namely, in the first embodiment, one or more configuration items against which it is preferable to take measures for preventing the occurrence of the failure are detected. Therefore, the first embodiment is effective for preventing the occurrence of the failure.

Described next is a second embodiment with reference to FIGS. 4-7. In the second embodiment, an IP address is used for identification information of a configuration item. In the second embodiment, an occurrence of a failure is also reported by a message.

FIG. 4 illustrates an operation of a detection server in the second embodiment. FIG. 4 illustrates the operations of two phases, a “learning phase” and a “detecting phase”. The operation of the detecting phase corresponds to the operation illustrated in FIG. 1 in the first embodiment.

The detection server in the second embodiment learns information corresponding to the “second frequency”, which has been described with respect to the first embodiment, in the learning phase. Then, in the detecting phase, a predictor of a failure of a certain type is detected. When the predictor of the failure is detected, the detection server calculates a value corresponding to the statistic, which has been described with respect to the first embodiment, and generates and outputs information corresponding to the result information, which has been described with respect to the first embodiment, according to the calculated statistic.

Described below are the details of the learning phase illustrated in FIG. 4. In FIG. 4, for convenience, IP addresses “172.16.1.2”, “10.0.7.6”, and “10.0.0.10” are respectively represented as “A”, “B”, and “C”.

The learning phase is a phase in which the detection server performs the learning based on the results of one or more predictor detections which have been performed during a period preceding an occurrence of a failure, in response to the actual occurrence of the failure. For example, in FIG. 4, the following operation sequence is illustrated.
At the time t1, a message M1 of the type “1” was output from a configuration item of an IP address A.
At the time t2, a message M2 of the type “2” was output from a configuration item of an IP address B.
At the time t3, a message M3 of the type “3” was output from a configuration item of an IP address C.
At the time t4, a message M4 of the type “4” was output from a configuration item of an IP address A.
At the time t5, a message M5 of the type “2” was output from a configuration item of an IP address B.
At the time t6, a message M6 of the type “3” was output from a configuration item of an IP address A.
At the time t7, a message M7 of the type “1” was output from a configuration item of an IP address A.
At the time t8, a message M8 of the type “2” was output from a configuration item of an IP address B.
At the time t9, a message M9 of the type “7” was output from a configuration item of an IP address B.

In an example illustrated in FIG. 4, the message of the type “7” is a message which reports an event in which “a specific type of failure occurred”. On the other hand, the messages of the types “1”, “2”, “3”, and “4” are messages which report events other than the occurrence of the failure. Hereinafter, for simplicity of description, the specific type of failure, whose occurrence is reported by the message of the type “7”, is sometimes simply referred to as a “failure #7”. In addition, a similar representation, such as a “failure #f”, is sometimes used. The type “7” is the type of a message or the type of failure.

In the second embodiment, a failure predictor is detected using a window 301. Hereinafter, a length of the window 301 is sometimes referred to as “T1”. The length T1 of the window 301 corresponds to the “first predetermined period” described with respect to the first embodiment. As illustrated by an arrow in FIG. 4, the window 301 slides along a time axis.

In the second embodiment, an occurrence of a failure within a period that starts from a point in time at which each message pattern is detected and has a predetermined length, is predicted. The period is hereinafter referred to as a “prediction target period”. The length of the prediction target period corresponds to the “second predetermined period” described with respect to the first embodiment, and hereinafter, the length of the prediction target period is sometimes referred to as “T2”.

When the failure #7 actually occurs at the time t9, the detection server receives the message M9. The detection server recognizes an occurrence of the failure #7 as a result of the reception of the message M9, and starts the process of the learning phase.

Specifically, the detection server retrieves a failure predictor which has been correctly detected as a predictor of the failure #7 at the time t9 (namely, a correct prediction of the occurrence of the failure #7 at the time t9). As described later in detail, in the second embodiment, every time the failure predictor is detected, a detection result is stored. Therefore, the detection server can recognize the results of one or more predictor detections which have been performed during a period preceding the occurrence of the failure at the time t9 by searching in the storage.

The prediction of the occurrence of the failure in the second embodiment is performed with respect to the future within the prediction target period as described above. Therefore, a correct prediction with respect to the occurrence of the failure #7 at the time t9 exists within a period which has a length of T2 and ends at the time t9, if it exists. In FIG. 4, a prediction target period 302, which ends at the time t9, is illustrated by a bidirectional arrow.

The detection server specifically retrieves the results of predictions which have been performed within the prediction target period 302, which ends at the time t9. FIG. 4 illustrates that six predictions which have been performed at the times t1, t2, t3, t5, t6, and t8 are correct. Specifically, FIG. 4 illustrates the following. Note that, in FIG. 4, a failure predictor which is detected with respect to a correct prediction (namely, a message pattern) is surrounded with a solid line, and a failure predictor which is detected with respect to an incorrect prediction is surrounded by a broken line.
At the time t1, a message M1 is output. In the window 301 which ends at the time t1, only the message M1 is included. Therefore, the detection server predicts an occurrence of a failure from a message pattern including only the message M1. As a result, in the prediction at the time t1, the detection server predicts that a failure #7 will occur within a prediction target period having a length of T2. It turns out at the time t9 that this prediction is correct.
At the time t2, a message M2 is output. In the window 301 which ends at the time t2, the messages M1 and M2 are included. Therefore, the detection server predicts an occurrence of a failure from a message pattern including the messages M1 and M2. As a result, in the prediction at the time t2, the detection server predicts that a failure #7 will occur within a prediction target period having a length of T2. It turns out at the time t9 that this prediction is correct.
At the time t3, a message M3 is output. In the window 301 which ends at the time t3, the messages M1, M2, and M3 are included. Therefore, the detection server predicts an occurrence of a failure from a message pattern including the messages M1, M2, and M3. As a result, in the prediction at the time t3, the detection server predicts that a failure #7 will occur within a prediction target period having a length of T2. It turns out at the time t9 that this prediction is correct.
At the time t4, a message M4 is output. In the window 301 which ends at the time t4, the messages M3 and M4 are included. Therefore, the detection server predicts an occurrence of a failure from a message pattern including the messages M3 and M4. As a result, in the prediction at the time t4, the detection server predicts that a failure will not occur within a prediction target period having a length of T2, or that a failure #f (where f≠7) will occur within a prediction target period having a length of T2. It turns out at the time t9 that this prediction is incorrect.
At the time t5, a message M5 is output. In the window 301 which ends at the time t5, the messages M4 and M5 are included. Therefore, the detection server predicts an occurrence of a failure from a message pattern including the messages M4 and M5. As a result, in the prediction at the time t5, the detection server predicts that a failure #7 will occur within a prediction target period having a length of T2. It turns out at the time t9 that this prediction is correct.
At the time t6, a message M6 is output. In the window 301 which ends at the time t6, the messages M4, M5, and M6 are included. Therefore, the detection server predicts an occurrence of a failure from a message pattern including the messages M4, M5, and M6. In the prediction at the time t6, the detection server predicts that a failure #7 will occur within a prediction target period having a length of T2. It turns out at the time t9 that this prediction is correct.
At the time t7, a message M7 is output. In the window 301 which ends at the time t7, the messages M6 and M7 are included. Therefore, the detection server predicts an occurrence of a failure from a message pattern including the messages M6 and M7. As a result, in the prediction at the time t7, the detection server predicts that a failure will not occur within a prediction target period having a length of T2, or that a failure #f (where f≠7) will occur within a prediction target period having a length of T2. It turns out at the time t9 that this prediction is incorrect.
At the time t8, a message M8 is output. In the window 301 which ends at the time t8, the messages M7 and M8 are included. Therefore, the detection server predicts an occurrence of a failure from a message pattern including the messages M7 and M8. In the prediction at the time t8, the detection server predicts that a failure #7 will occur within a prediction target period having a length of T2. It turns out at the time t9 that this prediction is correct.

In the example illustrated in FIG. 4 as described above, the detection server recognizes the following as a result of the retrieval above at the time t9 (namely, a retrieval of a correct prediction within the prediction target period 302).

Among the predictions which were performed within the prediction target period 302, six predictions at the times t1, t2, t3, t5, t6, and t8 correctly predicted the occurrence of the failure #7 at the time t9.
Among the six correct predictions, four correct predictions include a message of the type “1” in a message pattern indicating a failure predictor (namely, a message pattern included in the window 301 used for the prediction).
Among the six correct predictions, five correct predictions include a message of the type “2” in a message pattern indicating a failure predictor.
Among the six correct predictions, two correct predictions include a message of the type “3” in a message pattern indicating a failure predictor.
Among the six correct predictions, two correct predictions include a message of the type “4” in a message pattern indicating a failure predictor.

Hereinafter, a relative frequency at which, among correct predictions of the occurrence of the failure #f (namely, a failure which is reported by a message of the type “f”), a message of the type “n” is included in a “predictive pattern” is represented as “WF(f, n)”. The “predictive pattern” is a message pattern that is used for a prediction of an occurrence of a failure, and is a message pattern that is detected as a failure predictor, in other words.

In the second embodiment, the message pattern is a combination pattern that is not related to the temporal order of the output of a message. In the second embodiment, when two or more messages of the same type are included in the window 301, a duplication of the message is ignored. For example, four cases described below correspond to the same message pattern (hereinafter sometimes represented as “[1, 2]” for convenience).
A case in which a message of the type “1” is output first, and then, a message of the type “2” is output so that only the two messages are included in the window 301
A case in which a message of the type “2” is output first, and then, a message of the type “1” is output so that only the two messages are included in the window 301
A case in which a message of the type “1” is output first, a message of the type “2” is output, and then a message of the type “1” is output so that only the three messages are included in the window 301
A case in which a message of the type “1” is output first, a message of the type “2” is output, and then a message of the type “2” is output so that only the three messages are included in the window 301

It is obvious that there can be cases that correspond to the message pattern [1, 2] other than the four cases above. In some embodiments, a difference according to the number of times at which messages of the same type are included in the window 301 may be considered. For example, an embodiment in which the message patterns [1, 2], [1, 1, 2], and [1, 2, 2] are distinguished is possible.

In the example illustrated in FIG. 4, a value of WF (f, n) in the learning phase at the time t9 is as described below:

WF(7, 1)=4/6

WF(7, 2)=5/6

WF(7, 3)=2/6

WF(7, 4)=2/6

WF(f, n) is a specific example of the “second frequency” described with respect to FIG. 1. Correspondence relation between FIG. 1 and FIG. 4 is described below in detail.

A “point in time of occurrence” described with respect to FIG. 1 corresponds to the time t9 in FIG. 4. Therefore, “the past within a second predetermined period from the point in time of occurrence” described with respect to FIG. 1 corresponds to the prediction target period 302 which ends at the time t9. Accordingly, the times t1-t8 included in the prediction target period 302 in FIG. 4 respectively correspond to a “point in time of output” described with respect to FIG. 1. Therefore, a range of the window 301 which ends at each time tj (1≦j≦8) in FIG. 4 corresponds to each “window period” described with respect to FIG. 1.

Here, a “second message pattern” described with respect to FIG. 1 is a combination pattern of one or more messages that are included in the “window period”. Accordingly, in FIG. 4, each message pattern that is used for the prediction at the time tj (1≦j≦8) corresponds to the “second message pattern”.

At a certain time later than the time t9 (for example, the time t11 in the detecting phase described later), an occurrence of a failure #7 may be predicted. Specifically, the occurrence of the failure #7 may be predicted according to a “first message pattern” that is a combination pattern of P messages that are output from Q configuration items (1≦Q≦P). In this case, a “second frequency”, which is used for the calculation of a “statistic” with respect to a configuration item that has output a message of the type “n” included in the “first message pattern” among the Q configuration items, corresponds to WF(7, n).

In FIG. 4, below the time t8, which is the last “point in time of output” within the prediction target period 302, the values described above of WF(7, 1) and WF(7, 2) (i.e., 4/6 and 5/6) are illustrated. The values of WF (7, 3) and WF (7, 4) are omitted in FIG. 4 on account of paper width.

WF(f, n) in the second embodiment is a relative frequency as described above. Specifically, WF(f, n) is a value that is obtained by dividing the number of predictions in which a message of the type “n” is included in a predictive pattern, from among correct predictions of the occurrence of the failure #f, by the number of correct predictions of the occurrence of the failure #f. More accurately, an object for counting the respective values of a numerator and a denominator of WF(f, n) is limited within the prediction target period 302 that ends at a “point in time of occurrence” at which the failure #7 has actually occurred.

In FIG. 4, for the purposes of assisting understanding, the respective values of a numerator and a denominator, in counting the numerator and the denominator of WF (7, 1) from the time t1 within the prediction target period 302, are also illustrated in the line “WF (7, 1)”. For example, “¾”, which is illustrated below the time t5, represents the following:
The prediction at the time t5 is a fourth prediction in which the occurrence of the failure #7 is correctly predicted, within the prediction target period 302 (note that the prediction at the time t4 is incorrect).
In three of the four correct predictions, a predictive pattern includes a message of the type “1” (note that the message of the type “1” is included in predictive patterns at the times t1, t2, and t3, but is not included in a predictive pattern at the time t5).

Similarly, in FIG. 4, for the purpose of assisting the understanding, the respective values of a numerator and a denominator, in counting the numerator and the denominator of WF (7, 2) from the time t1 within the prediction target period 302, are also illustrated in the line “WF(7, 2)”.

As described above, in the learning phase in the second embodiment, the detection server performs the learning according to the results of one or more predictor detections which have been performed during a period preceding the occurrence of a failure, in response to the actual occurrence of the failure.

The reason why a correct prediction is possible at the times t1, t2, t3, t5, t6, and t8, which precede the occurrence of the failure #7 at the time t9, is that the failure #7 has already occurred at least once at a point in time before the time t1. Namely, when the failure #7 occurs before the time t1, a message pattern in each window during a prediction target period immediately before the occurrence of the failure #7 is learnt as a message pattern that co-occurs with the failure #7. When the failure #7 actually occurs several times, a co-occurrence frequency of each message pattern and the failure #7 can be calculated. The ditection server may weigh the respective learnt message patterns according to, for example, the co-occurrence frequency. Of course, the detection server performs a similar learning with respect to another type of failure.

As described above, the detection server performs a prediction at each of the times t1-t8 according to the learnt message pattern. As a result, in the example illustrated in FIG. 4, the six predictions at the times t1, t2, t3, t5, t6, and t8 happen to be correct.

As seen from the above descriptions, when the failure #7 occurs first, there are no message patterns that are predictive of the failure #7 that have been learnt. Accordingly, before the first occurrence of the failure #7, the occurrence of the failure #7 is not predicted. Therefore, the number of correct predictions is 0 during the prediction target period immediately before the first occurrence of the failure #7. In this case, WF(7, n) may for example be defined as 0.

Described next is the detecting phase in which the learning result in the learning phase described above is used. In the example illustrated in FIG. 4, at the time t10 after the time t9, a message M10 of the type “2” is output from a configuration item of the IP address B. At the time t11, a message M11 of the type “1” is output from a configuration item of the IP address A.

Between the times t9 and t10, one or more messages may be output further. Every time a message is output, the detection server performs a prediction on an occurrence of a failure according to a message pattern in a window which ends at a point in time of the output of the message.

For example, when the detection server receives the message M11 at the time t11, the detection server performs a prediction according to a message pattern [1, 2] (i.e., a pattern including the two messages M10 and M11) which is included in the window 303 that ends at the time t11. In the example illustrated in FIG. 4, assume that, in a prediction at the time t11, the detection server predicts that the failure #7 will occur within a prediction target period having a length of T2.

In the example illustrated in FIG. 4, assume that the occurrence of the failure #7 is predicted first at the time t11 after the time t9. Namely, assume that, in a prediction at the time t10 (and, in a case in which one or more messages are output between the times t9 and t10, a prediction according to a window which ends at a point in time of the output of each of the messages), the occurrence of the failure #7 is not predicted.

When the occurrence of the failure #7 is predicted at the time t11, the detection server generates and outputs information suggesting which configuration item in a computer system it would be effective to take measures against in order to prevent the predicted occurrence of the failure #7. Hereinafter, this information is referred to as “ranking information”. The ranking information corresponds to “result information” in FIG. 1. Namely, the process in the detection phase in the second embodiment corresponds to the process in FIG. 1.

For example, in the example illustrated in FIG. 4, the prediction at the time t11 corresponds to step S1 of FIG. 1. In this case, the two messages M10 and M11 included in the window 303 are used for the prediction, and therefore, a value of “P” in FIG. 1 is 2. In the example illustrated in FIG. 4, a configuration item that is a sender of the message M10 is different from a configuration item that is a sender of the message M11, and therefore, a value of “Q” in FIG. 1 is 2.

Similarly to step S2 of FIG. 1, in the second embodiment, for each of the Q configuration items, a statistic on a probability that the predicted failure #7 will occur in the configuration item in the future is calculated. In the second embodiment, as a specific example of the statistic, WF-IDF(f, n), which is defined by the expression (1), is used. WF-IDF(f, n) is a statistic that is calculated for a configuration item that has output a message of the type “n” in a message pattern (i.e., a predictive pattern) used as the basis for the prediction in the prediction of the occurrence of the failure #f.

WF-IDF(f,n)=WF(f,n)×log₁₀(1/DF(n)) (1)

WF(f, n) in the expression (1) is as described above with respect to FIG. 1. As described above, WF(f, n) corresponds to a “second frequency” described with respect to FIG. 1. On the other hand, DF(n) in the expression (1) is a specific example of a “first frequency” described with respect to FIG. 1. Namely, DF(n) indicates how many messages of the type (n) are output.

Specifically, DF(n) is a relative frequency. DF(n) at a certain time t is a relative frequency which indicates the number of windows that include a message of the type “n” among all windows that the detection server analyzes by the time t.

In other words, a denominator of DF(n) at the time t is the number of times at which the detection server analyzes a message pattern for the detection of a failure predictor by the time t. A numerator of DF(n) at the time t is the number of message patterns that include a message of the type “n” among all of the analyzed message patterns.

As described above, in the second embodiment, a duplication of a message of the same type in a window is ignored in a definition of a message pattern. Accordingly, the numerator of DF (n) at the time t is also the number of messages of the type “n” that are counted in all of the analyzed message patterns while ignoring the duplication of the message.

As described above, an embodiment in which the duplication of a message of the same type in a window is considered is possible. In this case, the numerator of DF(n) may be a value that is counted while ignoring the duplication of the message of the same type in the window (i.e., the number of windows including a message of the type “n”). Alternatively, the numerator of DF(n) may be a value that is counted while considering the duplication of the message of the same type in the window (i.e., the total number of messages of the type “n”).

In FIG. 4, only a value of DF(1) (i.e., 1200/12000) and a value of DF(2) (i.e., 6/12000) at the time t11 are illustrated on account of paper width. In FIG. 4, DF (3), DF (4), etc., are omitted; however, DF(n) is counted for each type.

Comparing DF(1) and DF(2), it is understood that a message of the type “2” is much rarer than a message of the type “1”. Nevertheless, there are no major differences between WF(7, 1) and WF(7, 2), and WF(7, 2) is larger than WF(7, 1). Namely, it is presumed that the message of the type “2” co-occurs more particularly with the failure #7 than with a failure of another type, and is a predictor that characterizes the failure #7. WF-IDF(f, n) in the expression (1) is an example of a statistic that reflects such presumption.

As is obvious from the expression (1), WF-IDF(f, n) in the expression (1) is an example of a statistic that monotonously decreases relative to DF(n) as a “first frequency” and monotonously increases relative to WF(f, n) as a “second frequency”. If WF-IDF(f, n) is defined to monotonously decrease relative to DF(n) and monotonously increase relative to WF(f, n), WF-IDF(f, n) may be defined by an expression other than the expression (1).

For example, the base of logarithms in the expression (1) may be changed according to an embodiment. WF-IDF(f, n) may be defined by an expression that does not use a logarithm. Of course, an expression including an addition or multiplication of appropriate coefficients may be used for defining WF-IDF(f, n).

For example, in the example illustrated in FIG. 4, a predictive pattern in the prediction at the time t11 of the occurrence of the failure #7 includes the messages M10 and M11. The type of the message M11 is “1”. Accordingly, the detection server calculates WF-IDF(7, 1) as a statistic for a sender of the message M11 (i.e., a configuration item of the IP address A). Similarly, the detection server calculates WF-IDF(7, 2) as a statistic for a sender of the message M10 of the type “2” (i.e., a configuration item of the IP address B).

A TF-IDF (term frequency-inverse document frequency), which is used in a field of information retrieval, is a product of a TF and an IDF. When only the TF is used, it is difficult to distinguish a term frequently appearing only in a specific document from a general term frequently appearing in many documents; however, an influence of the general term can be decreased by using the IDF. Namely, the IDF serves as a kind of noise filter. Therefore, a TF-IDF that is calculated with respect to a pair of a specific document and a term characterizing the specific document (i.e., a term frequently appearing only in the specific document) is larger than a TF-IDF that is calculated with respect to a pair of the specific document and a general term frequently appearing in various documents.

The multiplication “×log₁₀(1/DF(n))” in the expression (1) also serves as a kind of noise filter. For example, there may be a case in which a configuration item repeatedly outputs a message of the type “n” constantly at a relatively high frequency. In this case, at no matter what time a prediction is performed, a probability that a message of the type “n” will be included in a window is high. The message that is repeatedly output constantly does not co-occur only with a specific type of failure at a high frequency, and therefore, the relevance to the specific type of failure is low. When a message of the type “n” is repeatedly output constantly at a relatively high frequency, it is presumed that the importance of the configuration item that outputs the message of the type “n” is low in the prediction of the specific type of failure.

The multiplication “×log₁₀(1/DF(n))” in the expression (1) serves as a noise filter for reducing an influence of a message that is constantly and repeatedly output at a relatively high frequency as described above. Namely, the multiplication “×log₁₀(1/DF(n))” in the expression (1) is performed in order to more appropriately find a configuration item with higher importance in the prediction of a specific type of failure. In other words, by defining the “statistic” so as to monotonously decrease relative to the “first frequency”, an influence of a noise is reduced, and as a result, the accuracy of presented result information is increased.

When the occurrence of the failure #7 is predicted from a message pattern including a message of the type “n”, WF-IDF(f, n) represents the following. Namely, WF-IDF(f, n) represents the importance of a configuration item that outputs a message of the type “n”. More specifically, WF-IDF(f, n) represents how important the output of a message from a configuration item that has output the message of the type “n” is in the prediction of the occurrence of the failure #7. To say it in another way, WF-IDF(f, n) represents how tightly taking measures against an event that is a cause of the output of the message is related to the occurrence of the failure #7 in the configuration item that has output the message of the type “n”.

In the example illustrated in FIG. 4, the occurrence of the failure #7 is predicted at the time t11 according to the message pattern including the two messages M10 and M11 in the window 303. Information relating to a predictive pattern that is detected at the time t11 with respect to the failure #7 as described above is illustrated as detailed predictive information 304 in FIG. 4. The detailed predictive information 304 is information that associates an IP address of a configuration item that is a sender which has output the message with the type of the message, with respect to each message in the predictive pattern.

In the example illustrated in FIG. 4, as the message M11 of the type “1” has been output from a configuration item of the IP address A (172.16.1.2), the IP address A and a type of “1” are associated. As the message M10 of the type “2” has been output from a configuration item of the IP address B (10.0.7.6), the IP address B and a type of “2” are associated.

The detection server calculates WF-IDF(F, n) as described above with respect to a configuration item that is a sender of each message included in the predictive pattern. In the example illustrated in FIG. 4, the detection server calculates WF-IDF(7, 1) as represented as the expression (2) with respect to a sender of the message M11 (i.e., the configuration item of the IP address A). In addition, the detection server calculates WF-IDF(7, 2) as represented as the expression (3) with respect to a sender of the message M10 (i.e., the configuration item of the IP address B).

$$\begin{matrix}\begin{matrix}WF \text{-} IDF ( 7 , 1 ) = WF ( 7 , 1 ) \times {log}_{10} ( 1 / DF ( 1 ) ) \\ = 4 / 6 \times {log}_{10} ( 12000 / 1200 ) \\ \approx 0.67\end{matrix} & ( 2 ) \\ \begin{matrix}WF \text{-} IDF ( 7 , 2 ) = WF ( 7 , 2 ) \times {log}_{10} ( 1 / DF ( 2 ) ) \\ = 5 / 6 \times {log}_{10} ( 12000 / 6 ) \\ \approx 2.75\end{matrix} & ( 3 )\end{matrix}$$

In the second embodiment, the detection server ranks configuration items that are the senders of the messages included in the predictive pattern according to the respective calculated values of WF-IDF (f, n). Then, the detection server generates ranking information 305 indicating a result of ranking. The ranking information 305 is an example of “result information” described with respect to step S3 of FIG. 1.

As illustrated in FIG. 4, the ranking information 305 is information associating the following four types of information with the respective Q configuration items that are the senders of the P messages included in the predictive pattern (1≦Q≦P):
The ranking of the configuration item (i.e., the ranking provided as a result of the sorting by WF-IDF (f, n))
The IP address of the configuration item (i.e., identification information that identifies the configuration item)
The type of a message that has been output by the configuration item from among the messages included in the predictive pattern
WF-IDF (f, n) that is calculated with respect to the configuration item

There may be a case in which two or more messages included in the predictive pattern are output from one configuration item. Namely, as described with respect to FIG. 1, there may be a case of Q<P.

As an example, assume that both a message of the type “n1” and a message of the type “n2” are included in a predictive pattern of a failure #f and that these messages have been output from the same configuration item. In this case, the detection server calculates both WF-IDF (f, n1) and WF-IDF (f, n2) with respect to the configuration item that has output these two message. Then, the detection server adopts the larger value of WF-IDF (f, n1) and WF-IDF (f, n2). The adopted value is used for a sort key in the sorting of the Q configuration items.

After the generation of the ranking information 305, the detection server outputs the ranking information 305. The output of the ranking information 305 corresponds to step S4 of FIG. 1. The ranking information 305 includes identification information (i.e., the IP address B) that identifies a configuration item having the largest WF-IDF(f, n) as a statistic from among the Q (=2) configuration items that have output the P (=2) messages included in the predictive pattern. Namely, with respect to the failure #7 that is predicted to occur in the future, after the time t11, the ranking information 305 includes the IP address B as information that identifies a configuration item that is presumed to have the highest importance in the prediction of the failure #7. Accordingly, a person, such as a system administrator, can recognize a configuration item having a high relevance to the failure #7 by referring to the output ranking information 305. The system administrator, or the like, can draw up appropriate measures for preventing the occurrence of the failure #7.

The ranking information 305 includes the calculated WF-IDF(f, n) in addition to the ranking and the IP address. As an example, in a case in which there are no major differences between values of WF-IDF(f, n) of the first and second configuration items, or the other cases, the system administrator may decide to take measures against both of the first and second configuration items.

As described above, the ranking information 305 is information that is useful for preventing the occurrence of the failure #f. In another aspect, the detection server in the second embodiment strongly assists a system administrator, or the like, who performs a task of preventing the predicted occurrence of a failure.

Unfortunately, the failure #7 may actually occur later than the time t11 in spite of the output of the ranking information 305 (and the performing of the measures by the system administrator). When this happens, the detection server performs the process in the learning phase again, in response to the occurrence of the failure #7. If the failure #7 actually occurs in the future within a prediction target period having a length of T2 from the time t11, the prediction at the time t11 is treated as a “correct prediction” in the second learning phase, and is considered in the calculation of new WF(7, 1) and WF(7, 2).

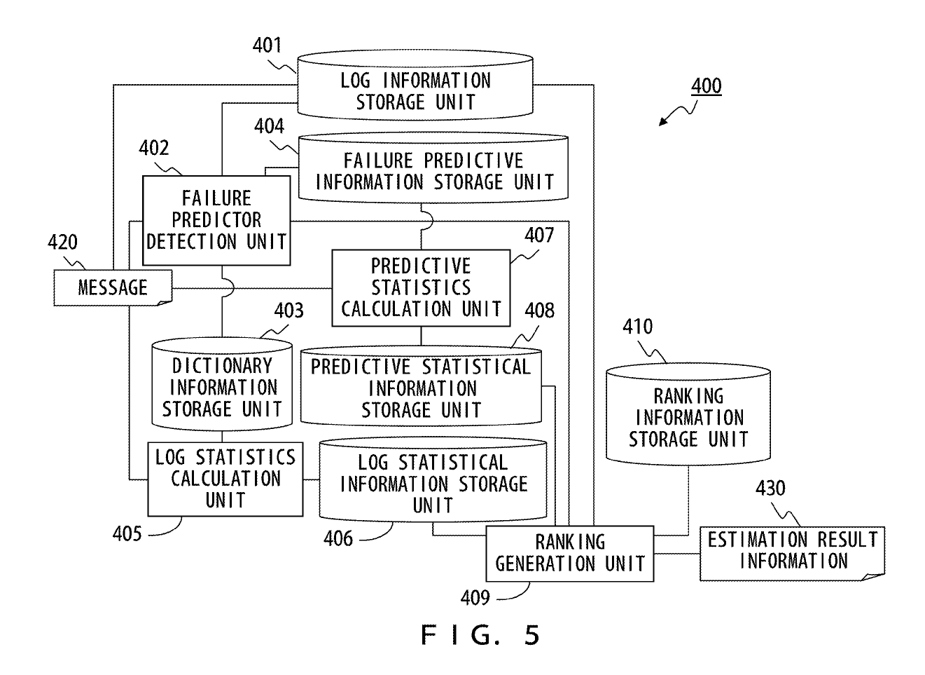

With reference to FIGS. 5-7, the further details of the second embodiments described with reference to FIG. 4 are described next.

FIG. 5 is a block diagram of the detection server in the second embodiment. The detection server that performs the processes of the learning phase and the detecting phase in FIG. 4 may be specifically a detection server 400 in FIG. 5.

The detection server 400 receives a message 420 as an input from various configuration items in the computer system, and outputs estimation result information 430. Specifically, the estimation result information 430 may be, for example, the ranking information 305 in FIG. 4.

The detection server 400 includes a log information storage unit 401, a failure predictor detection unit 402, a dictionary information storage unit 403, and a failure predictor information storage unit 404. The detection server 400 further includes a log statistics calculation unit 405, a log statistical information storage unit 406, a predictive statistics calculation unit 407, a predictive statistical information storage unit 408, a ranking generation unit 409, and a ranking information storage unit 410.

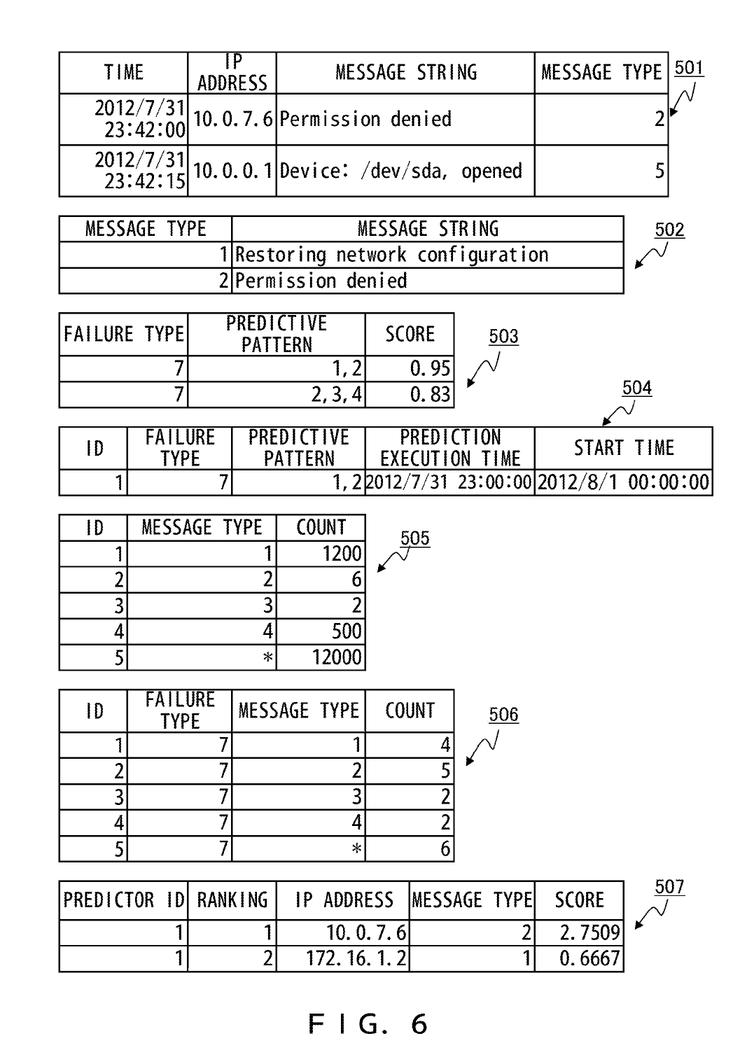

The message 420 is stored in the log information storage unit 401. For example, the messages M1-M11 in FIG. 4 are stored in the log information storage unit 401. The details of the log information storage unit 401 are described below, along with FIG. 6.

When the detection server 400 receives one message 420, the failure predictor detection unit 402 predicts whether a failure is likely to occur according to a message pattern in a window that ends at a point in time of the reception of the message 420. A case in which the occurrence of a failure is predicted by the failure predictor detection unit 402 is, in other words, a case in which a failure predictor (specifically, a predictive pattern) is detected by the failure predictor detection unit 402. For example, in FIG. 4, the performing of predictions at the times t1-t8 and t11 is illustrated.

The failure predictor detection unit 402 detects a predictor using dictionary information stored in the dictionary information storage unit 403. As described below in detail along with FIG. 6, two types of dictionary information are used in the second embodiment.

When the failure predictor detection unit 402 detects the failure predictor, the failure predictor detection unit 402 stores the detected result in the failure predictor information storage unit 404. The details of the failure predictor information storage unit 404 are described below along with FIG. 6.

As is obvious from the above descriptions regarding FIG. 4, a value of DF(n) changes with respect to each n every time the detection server 400 receives one message 420. The log statistics calculation unit 405 calculates one type of statistic for the calculation of the DF(n) value for each n (specifically, values of a numerator and a denominator of DF(n)).

Then, the log statistics calculation unit 405 stores the calculated value to the log statistical information storage unit 406. The details of the log statistical information storage unit 406 are described below along with FIG. 6.

When the message 420 received by the detection server 400 is a message of a type of reporting the actual occurrence of a failure, the detection server 400 performs the process in the learning phase in FIG. 4.

For example, the message M9 in FIG. 4 is an example of the message 420 that reports the occurrence of the failure #7. When the detection server 400 receives the message M9 at the time t9, the predictive statistics calculation unit 407 refers to information stored in the failure predictor information storage unit 404, and reads a result of a prediction performed during the prediction target period 302. Then, the predictive statistics calculation unit 407 calculates one type of statistic used for the calculation of WF(f, n) (i.e., values of a numerator and a denominator of WF(f, n)) according to the read information. In the example illustrated in FIG. 4, f=7, and n=1, 2, 3, or 4.

The predictive statistics calculation unit 407 stores the calculated result to the predictive statistical information storage unit 408. The details of the predictive statistical information storage unit 408 are described below along with FIG. 6.

As illustrated at, for example, the time t11 in FIG. 4, when the failure predictor detection unit 402 predicts the occurrence of a failure, the ranking generation unit 409 generates the estimation result information 430. As described above, the estimation result information 430 is information such as the ranking information 305. Specifically, the ranking generation unit 409 calculates WF-IDF (f, n) with reference to the log statistical information storage unit 406 and the predictive statistical information storage unit 408, and generates the estimation result information 430 according to the calculated WF-IDF(f, n).

The ranking generation unit 409 outputs the generated estimation result information 430. For example, the ranking generation unit 409 may store the estimation result information 430 in the ranking information storage unit 410. In some embodiments, the ranking information storage unit 410 may be omitted. Further, the ranking generation unit 409 may output the estimation result information 430 on a display. The ranking generation unit 409 may transmit (namely, output) an electronic email or an instant message including the estimation result information 430 to a system administrator.

The detection server 400 in FIG. 5 may be specifically the computer 100 in FIG. 2. When the detection server 400 is realized by the computer 100, FIG. 2 and FIG. 5 correspond to each other as described below.

The detection server 400 receives the message 420 through the communication interface 103. The detection server 400 may output the estimation result information 430 to the output device 105, to the storage device 106, or to the storage medium 110 through the driving device 107. Of course, the detection server 400 may transmit the estimation result information 430 through the communication interface 103 and the network 120.

The log information storage unit 401, the dictionary information storage unit 403, the failure predictor information storage unit 404, the log statistical information storage unit 406, the predictive statistical information storage unit 408, and the ranking information storage unit 410 may be realized by the storage 106. The failure predictor detection unit 402, the log statistics calculation unit 405, the predictive statistics calculation unit 407, and the ranking generation unit 409 may be realized by the CPU 101 that executes a program.

The detection server 400 in FIG. 5 may be the computer 200 in FIG. 3. In this case, the messages 420 are output from various configuration items in the computer system 230, and are received by the computer 200 as the detection server 400. In addition, a system administrator of the computer system 230 which refers to the estimation result information 430 output from the detection server 400, determines which configuration item in the computer system 230 measures are taken against, and performs appropriate measures.

A specific example of information stored in various storage units in FIG. 5 is described next with reference to FIG. 6. FIG. 6 is a diagram illustrating an example of each table used in the second embodiment.

A log table 501 is an example of information stored in the log information storage unit 401. Each entry in the log table 501 corresponds to each message 420 received by the detection server 400. Each entry in the log table 501 may include, for example, the following four fields:
Time at which the detection server 400 receives the message 420
IP address that identifies a configuration item that has output the message 420
String included in the message 420
Type of the message 420

For example, a first entry in the log table 501 corresponds to a message 420 that the detection server 400 receives from a configuration item that is identified by the IP address B (10.0.7.6) at 23:42, Jul. 31, 2012. The message includes a string of “Permission Denied”, and the type corresponding to this string is “2”. Every time the detection server 400 receives the message 420, the detection server 400 adds a new entry corresponding to the received message 420 to the log table 501.

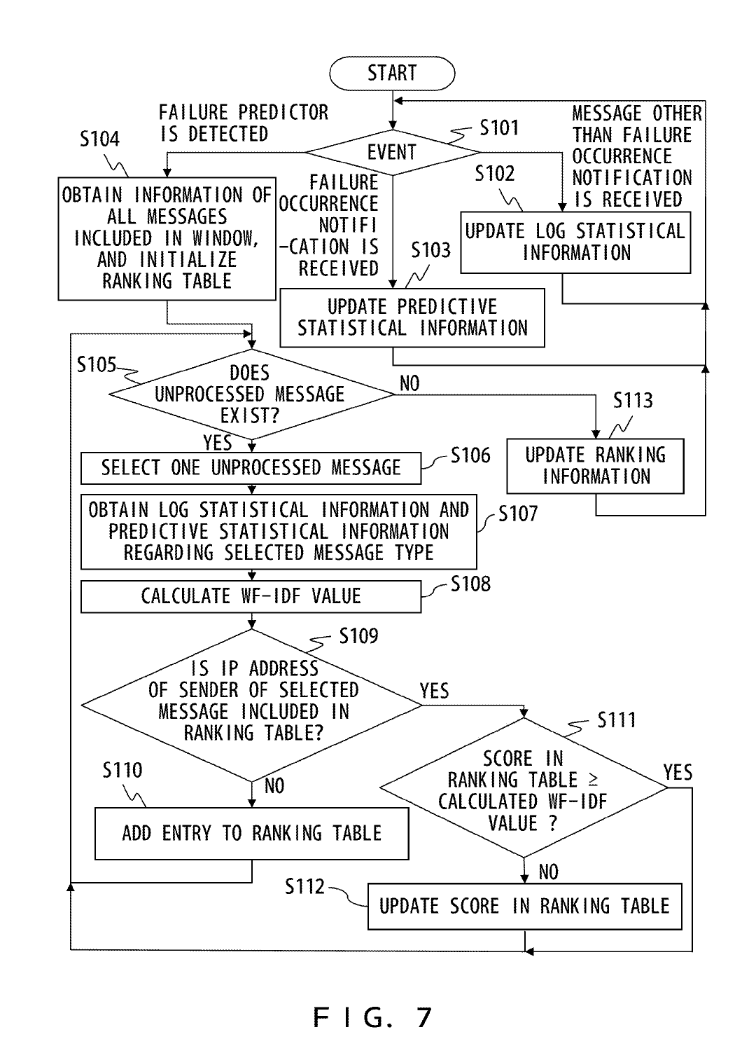

Although the details are described below with respect to step S104 in FIG. 7, a message type in the log table 501 may be omitted. Alternatively, when the log table 501 includes the message type, the message type may be recorded as described below.

When the detection server 400 receives the message 420, the detection server 400 refers to a message dictionary table 502 as described below. Then, the detection server 400 judges the type of the message 420 according to the message dictionary table 502 and a string included in the message 420, and records the judgment result as a message type in the log table 501.

The message dictionary table 502 is an example of information stored in the dictionary information storage unit 403. Each entry in the message dictionary table 502 corresponds to one type of message. As described above, some types of messages respectively indicate the occurrence of a failure, and the other types of messages respectively indicate an event other than the occurrence of the failure. Each entry in the message dictionary table 502 may include, for example, the following two fields:
Message type
String included in a message classified in the message type

For example, a second entry in the message dictionary table 502 indicates that the message 420 including the string “Permission denied” is classified in the type “2”. Accordingly, the message type of a first entry in the log table 501 is recorded as “2” as described above.

An actual string included in the respective messages 420 may be a string that includes a fixed string that is predetermined according to a type, and a string variable according to an environment, or the like. In this case, the judgment of the message type using the message dictionary table 502 may be performed according to a partial matching, not a full matching, of a message string in the message dictionary table 502 and a string included in the received message 420.

The message dictionary table 502 may be a static table prepared beforehand, or may be learnt dynamically. The message dictionary table 502 may be learnt according to, for example, a known method.

A pattern dictionary table 503 is also an example of the information stored in the dictionary information storage unit 403. Each entry in the pattern dictionary table 503 may include, for example, the following three fields:
Failure type (in an example illustrated in FIG. 6, represented specifically by the type of a message reporting an occurrence of the type of failure)
Predictive pattern of the type of failure (namely, this is a message pattern that is predictive of the type of failure, and, in the example illustrated in FIG. 6, it is represented specifically by a list of the types of messages included in the message pattern.)
Score indicating at what degree of probability the occurrence of the type of failure is predicted from the predictive pattern

The score may be omitted in some embodiments. The detection server 400 may dynamically learn the pattern dictionary table 503 according to, for example, a known method. The score may be, for example, a value based on a co-occurrence frequency of an actual failure and a message pattern which are observed during the learning.

For example, at the time t11 in FIG. 4, the failure predictor detection unit 402 recognizes that the two messages M10 and M11 are included in the window 303. When the log table 501 includes a message type, the failure predictor detection unit 402 may recognize the respective types of the messages M10 and M11 from the log table 501. Alternatively, the failure predictor detection unit 402 may recognize the respective types of the messages M10 and M11 according to a message string in the log table 501 and the message dictionary table 502.

In any case, the failure predictor detection unit 402 recognizes that the respective types of the messages M10 and M11 are “2” and “1”. Namely, the failure predictor detection unit 402 recognizes the message pattern [1, 2] corresponding to the window 303.

Accordingly, the failure predictor detection unit 402 retrieves the message pattern [1, 2] in the pattern dictionary table 503. As a result, in the example illustrated in FIG. 6, a first entry in the pattern dictionary table 503 is found.

Accordingly, the failure predictor detection unit 402 recognizes that the type of a failure predicted from the message pattern [1, 2] is “7”. As described above, the failure predictor detection unit 402 detects the message pattern [1, 2] as a predictor of the failure #7 at the time t11. The failure predictor detection unit 402 may determine, according to a score value and a threshold value, whether to detect a message pattern corresponding to a window as a failure predictor.

The failure predictor detection unit 402 may predict an occurrence of failures of two or more types from one message pattern. Namely, in the pattern dictionary table 503, predictive patterns of two or more entries corresponding to different failure types may happen to be the same message pattern.

A failure predictor table 504 is an example of information stored in the failure predictor information storage unit 404. The failure predictor detection unit 402 adds a new entry to the failure predictor table 504 every time the failure predictor detection unit 402 detects one predictive pattern. Each entry in the failure predictor table 504 may include, for example, the following five fields:
ID (identification) that identifies each entry in the failure predictor table 504
Type of a failure that the failure predictor detection unit 402 predicts to occur
Predictive pattern that the failure predictor detection unit 402 detects regarding the type of failure (namely, a message pattern that the failure predictor detection unit 402 uses as the basis for the prediction of the type of failure)
Time at which the failure predictor detection unit 402 performs a prediction
Prediction start time in a case in which the failure predictor detection unit 402 predicts when the type of failure starts (namely, when the type of failure occurs)

The start time may be omitted in some embodiments. Alternatively, when the failure predictor detection unit 402 predicts by when the predicted type of failure is likely to occur, there may further be an end time field indicating the prediction time. When the failure predictor detection unit 402 predicts a period during which a failure is likely to occur, there may be both a start time field and an end time field.

The log statistics table 505 is an example of information stored in the log statistical information storage unit 406. In the log statistics table 505, information for the calculation of DF(n) as described with respect to FIG. 4 is stored. Specifically, each entry in the log statistics table 505 includes the following three fields:
ID that identifies the entry
Message type
Count

With respect to an optional message type “n”, a count of an entry in which a message type is “n” indicates a numerator of DF(n). Further, in the second embodiment, for every n, a denominator of DF(n) is a common value (namely, the total number of windows that have been analyzed by the failure predictor detection unit 402). The common value is recorded as a count in an entry in which a message type is illustrated as “*” for convenience.

FIG. 6 illustrates five entries in the log statistics table 505 at the time t11 in FIG. 4. The log statistics table 505 may further include other entries corresponding to message types other than “1”-“4”; however, the other entries are omitted in FIG. 6.

A predictive statistics table 506 is an example of information stored in the predictive statistical information storage unit 408. In the predictive statistics table 506, information for the calculation of WF(f, n) as described with respect to FIG. 4 is stored. Specifically, each entry of the predictive statistics table 506 includes the following four fields:
ID that identifies the entry
Failure type
Message type
Count

With respect to a combination of optional f and n, a count of an entry in which a failure type is “f” and a message type is “n” indicates a numerator of WF(f, n). Further, in the second embodiment, with respect to a failure type of “f”, for every n, a denominator of WF (f, n) is a common value (namely, the number of correct predictions among the predictions performed during a prediction target period which ends at a point in time of the occurrence of a failure). The common value is recorded as a count in an entry in which a message type is illustrated as “*” for convenience.

FIG. 6 illustrates five entries in the prediction statistics table 506 at the time t11 in FIG. 4. In other words, FIG. 6 illustrates the contents that are learnt in response to the occurrence of the failure #7 at the time t9 in FIG. 4. The predictive statistics table 506 may further include other entries corresponding to failure types other than “7”; however the other entries are omitted in FIG. 6.

A ranking table 507 is generated in the detecting phase in FIG. 4. The ranking table 507 is similar to the ranking information 305 in FIG. 4, except in a “predictive ID” described below. Namely, each entry in the ranking table 507 corresponds to a configuration item that is a sender of any one or more messages in the predictive pattern detected by the failure predictor detection unit 402. Further, each entry in the ranking table 507 includes the following five fields:
Ranking
IP address
Message type
Score (specifically, WF-IDF(f, n))

The predictive ID is identification information for distinguishing pieces of ranking information respectively corresponding to a plurality of predictions in the ranking information storage unit 410. Accordingly, when the ranking table 507 is output as the estimation result information 430, the predictive ID may be omitted.

In an entry corresponding to a configuration item that has output two or more messages in a predictive pattern, a list of the types of the two or more messages is stored in a field of a message type.

The ranking table 507 may be output as the estimation result information 430 to, for example, the output device 105 or another device outside the detection server 400. Further, each entry in the ranking table 507 may be stored in the ranking information storage unit 410.

Described next is a process that is performed by the detection server 400, with reference to a flowchart of FIG. 7. Among various processes performed by the detection server 400, the storage of a message 402 to the log information storage unit 401, the learning of the pattern dictionary table 503, and the detection of a failure predictor by the failure predictor detection unit 402 may be similar to known processes. Therefore, these processes are omitted in FIG. 7. FIG. 7 illustrates, specifically, processes that are performed by the log statistics calculation unit 405, the predictive statistics calculation unit 407, and the ranking generation unit 409.

In step S101, the detection server 400 awaits an occurrence of some kind of event. When an event in which a message 420 other than a failure occurrence notification has been received occurs, the log statistics calculation unit 405 performs the process of step S102. On the other hand, when an event in which a message 420 that is a failure occurrence notification has been received occurs, the predictive statistics calculation unit 407 performs the process of S103. When an event in which a failure predictor is detected by the failure predictor detection unit 402 occurs, the ranking generation unit 409 performs the processes of steps S104-S113.

For example, at all of the times t1-t8, t10, and t11 in FIG. 4, the process of step S102 is performed. At the time t9 in FIG. 4, the process of step S103 is performed. When an occurrence of some type of failure is predicted by the failure predictor detection unit 402, the processes of step S104-S113 are performed.

In step S102, the log statistics calculation unit 405 updates log statistical information. Specifically, the log statistics calculation unit 405 updates two or more entries in the log statistics table 505 in the log statistical information storage unit 406.

The log statistics calculation unit 405 retrieves a message included in a window which has a length of T1 and ends at a point in time of the reception of a message 420 in step S101 from the log table 501. As a result of the retrieval, one or more messages that include at least the message 420 received in step S101 are found. For example, when the process of step S102 is performed in response to the reception of the message M3 at the time t3 in FIG. 4, the messages M1-M3 are found.

For each of the found messages, the log statistics calculation unit 405 increments a count of an entry corresponding to the type of the message in the log statistics table 505 by 1. Further, the log statistics calculation unit 405 also increments a count of an entry of the message type “*” in the log statistics table 505 by 1. When the process of step S102 is finished, the detection server 400 awaits an occurrence of an event in step S101 again.

For example, when the message M11 is received at the time t11 in FIG. 4, the operation in step S102 is as follows. In the window 303 which ends at the time t11, the two messages M10 and M11 are included, and the types thereof are “2” and “1”, respectively. Therefore, in this case, in step S102, the log statistics calculation unit 405 increments the respective counts of three entries of the message types “2”, “1”, and “*” in the log statistics table 505 by 1.

In step S103, the predictive statistics calculation unit 407 updates predictive statistical information. Specifically, the predictive statistics calculation unit 407 updates some specific entries in the predictive statistics table 506 in the predictive statistical information storage unit 408 as described below.

The predictive statistics calculation unit 407 retrieves the predictive statistics table 506 using the type of a failure reported by the message 420, which is received in step S101, as a retrieval key. All entries that are found as a result of the retrieval are entries to be updated in step S103.

For example, when step S103 is performed at the time t9 in FIG. 4, all entries having a failure type of “7” are found. The predictive statistics calculation unit 407 initializes a count of each of the entries found in the predictive statistics table 506 to 0.

The predictive statistics calculation unit 407 retrieves a prediction result performed within a prediction target period having a length of T2 prior to a failure occurrence reported by the message 420 received in step S101, from the failure predictor information storage unit 404.

For example, in a case in which step S103 is performed at the time t9 in FIG. 4, when the predictive statistics calculation unit 407 searches the failure predictor information storage unit 404, the results of eight predictions at the times t1-t8 are found. Namely, as a result of the retrieval, eight entries in the failure predictor table 504 are found.

The predictive statistics calculation unit 407 judges, with respect to each of the entries found in the failure predictor table 504, whether the failure type of the entry is the same as the failure type reported by the message 420 which is received in step S101.

When these two types are different from each other, the predictive statistics calculation unit 407 ignores the entry in the failure predictor table 504. This is because the entry in the failure predictor table 504 indicates an incorrect prediction.

When the two types are the same, the predictive statistics calculation unit 407 refers to a predictive pattern stored in the entry in the failure predictor table 504 (i.e., a predictive pattern that is proven to be correct). Then, the predictive statistics calculation unit 407 performs the following processes with respect to each message type included in the predictive pattern.
A process of incrementing a count that is associated with a pair of a failure type reported by the message 420, which is received in step S101, and the message type included in the predictive pattern by 1, in the predictive statistics table 506 A process of incrementing a count that is associated with a pair of a failure type reported by the message 420, which is received in step S101, and the type “*” by 1, in the predictive statistics table 506

For example, when step S103 is performed at the time t9 in FIG. 4, the predictive statistics calculation unit 407 ignores two entries corresponding to the predictions at the times t4 and t7 among the eight entries that are found in the failure predictor table 504. On the other hand, the predictive statistics calculation unit 407 performs the processes described above with respect to the respective message types included in the respective predictive patterns of the other six entries. As a result, the respective count values of five entries having the IDs “1” to “5” in the predictive statistics table 506 are updated to values illustrated in FIG. 6.

As described above, in step S103, the process in the learning phase in FIG. 4 is performed, and the learning result is reflected to the predictive statistics table 506. When the process of step S103 is finished, the detection server 400 awaits an occurrence of an event in step S101 again.

The processes of steps S104-S113 are performed by the ranking generation unit 409 when a failure occurrence is predicted by the failure predictor detection unit 402 (namely, when a failure predictor is detected). The processes of steps S104-S113 correspond to those of steps S2-S4 in FIG. 1, and correspond to the detecting phase in FIG. 4.

In step S104, the ranking generation unit 409 obtains information of all of the messages that are included in a window used in the failure detection by the failure predictor detection unit 402, and initializes the ranking information (specifically, the ranking table 507) to empty.

For example, when the failure predictor detection unit 402 predicts that a failure is likely to occur in the future within a prediction target period having a length of T2, a start time and an end time of the window used in the prediction may be reported to the ranking generation unit 409 in addition to the prediction result. Then, the ranking generation unit 409 can obtain the entries of all of the messages included in the window. The ranking generation unit 409 may only obtain at least an IP address and a message type in the log table 501.

In some embodiments, the failure predictor detection unit 402 may report an IP address of a sender of each message included in the window and each message type, in addition to the prediction result, to the ranking generation unit 409. In this case, the ranking generation unit 409 can obtain the IP address and the message type for all of the messages included in the window without referring to the log table 501. Further, in this case, the message type in the log table 501 may be omitted.

As an example, assume that the failure predictor detection unit 402 predicts an occurrence of a failure #7 at the time t11 in FIG. 4. In this case, in step S104, the ranking generation unit 409 obtains at least a message type and an IP address of a sender with respect to all of the messages included in the window 303, from the log table 501 or the failure predictor detection unit 402. Namely, in step S104, the ranking generation unit 409 obtains at east the information illustrates as the detailed predictive information 304 in FIG. 4.

Further, as described above, in step S104, the ranking generation unit 409 initializes the ranking table 507.

Next, in step S105, the ranking generation unit 409 judges whether there are any unprocessed messages among the messages whose information has been obtained in step S104. If there are any unprocessed messages, the ranking generation unit 409 performs the process of step S106 next. If all of the messages whose information has been obtained in step S104 have been processed, the ranking generation unit 409 performs the process of step S113 next.

In step S106, the ranking generation unit 409 selects one unprocessed message. For example, when the ranking generation unit 409 obtains information on the messages M10 and M11 in FIG. 4 in step S104, the ranking generation unit 409 selects one of the messages M10 and M11. Hereinafter, the message selected in step S106 is referred to as a “selected message”.

Next, in step S107, the ranking generation unit 409 obtains log statistical information and predictive statistical information on the type of the selected message. For convenience of description, assume that the type of the selected message is “n” and a failure #f is predicted by the failure predictor detection unit 402. In this case, in step S107, the ranking generation unit 409 obtains, specifically, the four values described below.

The ranking generation unit 409 refers to an entry having a message type value of “n” in the log statistics table 505, and reads a count value. The read value corresponds to a numerator of DF(n).

Further, the ranking generation unit 409 refers to an entry having a message type value of “*” in the log statistics table 505, and reads a count value. The read value corresponds to a denominator of DF(n).

In addition, the ranking generation unit 409 refers to an entry having a failure type value of “f” and a message type value of “n” in the predictive statistics table 506, and reads a count value. The read value corresponds to a numerator of WF(f, n).

Then, the ranking generation unit 409 refers to an entry having a failure type value of “f” and a message type value of “*” in the predictive statistics table 506, and reads a count value. The read value corresponds to a denominator of WF(f, n).

As an example, when the selected message is a message M10 in FIG. 4, in step S107, a numerator and a denominator of DF(2) illustrated in FIG. 4 (i.e., 6 and 12000), and a numerator and a denominator of WF(7, 2) illustrated in FIG. 4 (i.e., 5 and 6) are obtained.

Next, in step S108, the ranking generation unit 409 calculates a value of WF-IDF (f, n) according to the expression (1), using the four values obtained in step S107. As an example, when the selected message is the message M10 in FIG. 4, a value of about 2.75 is calculated as represented in the expression (3). On the other hand, when the selected message is the message M11 in FIG. 4, a value of about 0.67 is calculated as represented in the expression (2).

Next, in step S109, the ranking generation unit 409 judges whether an IP address of a sender of the selected message has already been included in the ranking table 507.

As an example, when the selected message is the message M10 in FIG. 4, the ranking generation unit 409 retrieves the ranking table 507 using the IP address B (10.0.7.6), which identifies a configuration item of the sender of the message M10, as a retrieval key. As a result of retrieval, when an entry is found, the ranking generation unit 409 judges that the IP address of the sender of the selected message has already been included in the ranking table 507. In contrast, when no entries are found, the ranking generation unit 409 judges that the IP address of the sender of the selected message is not included in the ranking table 507.

When the IP address of the sender of the selected message is not included in the ranking table 507, the ranking generation unit 409 next performs the process of step S110. In contrast, when the IP address of the sender of the selected message has already been included in the ranking table 507, the ranking generation unit 409 next performs the process of step S111.

In step S110, the ranking generation unit 409 adds a new entry including the following four values to the ranking table 507:
ID of a prediction result that is reported from the failure predictor detection unit 402 in step S101
IP address of a sender of a selected message
Type of the selected message
WF-IDF value that is calculated as a score of the selected message in step S108

As an example, assume that the failure predictor detection unit 402 predicts an occurrence of a failure from a message pattern and stores the prediction result along with the ID “p” in the failure predictor table 504. In this case, in step S101, the ID “p” along with the prediction result is reported from the failure predictor detection unit 402 to the ranking generation unit 409. The ID “p” that is reported as described above is a predictor ID in step S110.

In the new entry that is added in step S110, a field of ranking may be empty. After the addition of the entry, the ranking generation unit 409 performs the judgment of step S105 again.

On the other hand, when two or more messages that are output from one configuration item are included in a window, step S111 is performed with respect to a message that is selected second or later in step S106 from among the two or more messages.

Specifically, in step S111, the ranking generation unit 409 adds the type of the selected message to a list of a message type field in the entry that is found as a result of the retrieval of the ranking table 507 in step S109. In addition, in step S111, the ranking generation unit 409 judges whether a score in the ranking table 507 is WF-IDF (f, n), which is calculated in step S108, or larger. Note that the “score in the ranking table 507” is specifically a score in an entry that is found as a result of the retrieval of the ranking table 507 in step S109.

When the score in the ranking table 507 is the calculated WF-IDF (f, n) or larger, the score in the entry above does not need to be updated. Accordingly, in this case, the ranking generation unit 409 next performs the judgment of step S105.

In contrast, when the score in the ranking table 507 does not exceed the calculated WF-IDF(f, n), the ranking generation unit 409 next updates the score in the ranking table 507 in step S112. Specifically, the ranking generation unit 409 replaces the score in the entry that is found as a result of the retrieval of the ranking table 507 in step S109 with WF-IDF(f, n) calculated in step S108.

After the updating of the score in step S112 as described above, the ranking generation unit 409 performs the judgment of step S105 again.

As an example, there may be a case in which both a message of the type “n1” and a message of the type “n2” are included in a predictive pattern of a failure #7, and the messages are output from the same configuration item. According to steps S109-S112 described above, in this case, the larger value of WF-IDF (f, n1) and WF-IDF (f, n2) is adopted as a score.

As an example, assume that the message of the type “n1” has a co-occurrence frequency with a failure #f that is lower than a co-occurrence frequency with another type of failure, or has a relatively high co-occurrence frequency with all types of failures. Namely, assume that WF(f, n1) is small, or DF (n1) is large. On the other hand, assume that a message of the type “n2” has a relatively high co-occurrence frequency with the failure #f, and has a relatively low co-occurrence frequency with the other types of failures. Namely, assume that WF(f, n2) is large, and WF(g, n2) is small, where f g, (in other words, in another aspect, DF(n2) is relatively small).

In this case, WF-IDF (f, n2) is larger than WF-IDF (f, n1). Further, in this case, the relevance between the message of the type “n2” and the failure #f is higher than the relevance between the message of the type “n1” and the failure #f. Namely, the message of the type “n2” characterizes the failure #f more than the message of the type “n1”. Accordingly, a configuration item having higher importance in the prediction of the failure #f is a configuration item of a sender of the message of the type “n2”.

Accordingly, the ranking generation unit 409 adopts the largest of two or more WF-IDF(f, n) values that are calculated for one configuration item according to steps S109-S112.

When the processes of steps S106-S112 are finished with respect to all of the messages whose information has been obtained in step S104, the ranking generation unit 409 sorts entries in the ranking table 507 in descending order of scores (i.e., WF-IDF values) in step S113. Then, the ranking generation unit 409 records a ranking according to the sorting result in each of the entries. In FIG. 6, a ranking table 507 is illustrated that is ranked as described above.

Further, the ranking generation unit 409 outputs the ranking table 507 as the estimation result information 430 in step S113. As an example, the ranking generation unit 409 may add all of the entries in the ranking table 507 to the ranking information storage unit 410. The ranking generation unit 409 may output the ranking table 507 to the output device 105, such as a display, or may output the ranking table 507 to another device through the communication interface 103. The ranking generation unit 409 may transmit, for example, an electronic mail, an instant message, or the like, including the ranking table 507.

After the output in step S113, the detection server 400 awaits an occurrence of an event in step S101 again.

In the second embodiment described above, the estimation result information 430 that gives a useful suggestion for preventing a failure occurrence is output from the detection server 400. Accordingly, a system administrator can easily judge which configuration item it is effective to take measures against in order to prevent a failure occurrence by referring to the estimation result information 430. As an example, when a system administrator refers to the ranking table 507 in FIG. 6, the system administrator can judge that a configuration item having a high relevance to the prediction of the failure #7 is a configuration item that is identified by the IP address B (10.0.7.6). In some cases, the system administrator may judge according to the ranking table 507 that it is important to take measures against a configuration item that is identified by the IP address B (10.0.7.6) in order to prevent the predicted occurrence of the failure #7.

Accordingly, the second embodiment provides an effect of improving the availability of a computer system by preventing an occurrence of a failure in the computer system.

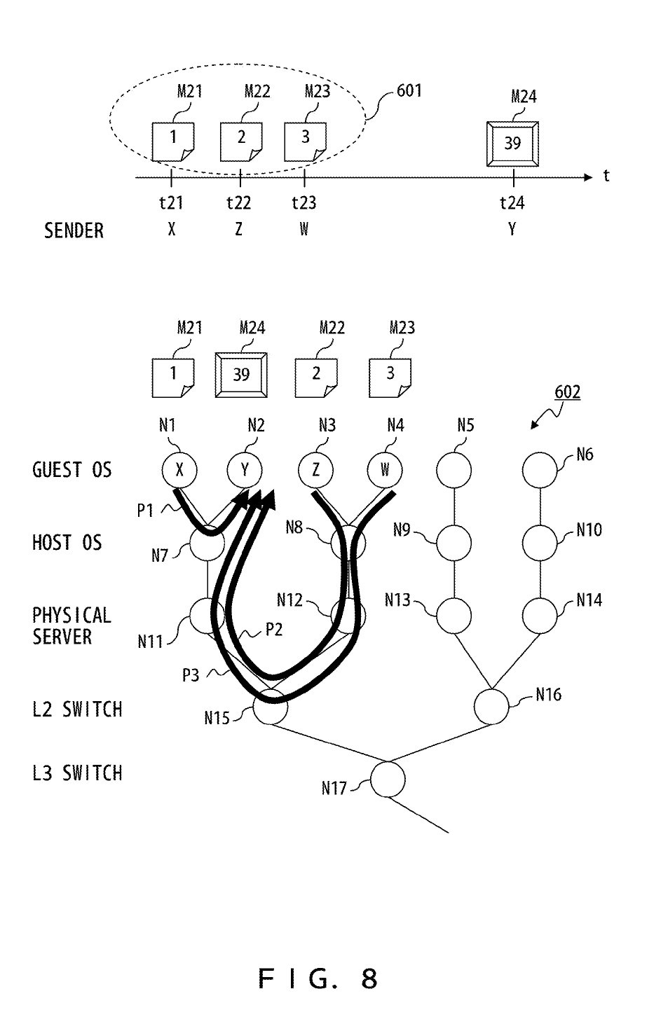

Described next is a third embodiment with reference to FIGS. 8-14. In the third embodiment, more reliable information (hereinafter referred to as “refined ranking information”) is generated from the ranking information that is generated in the detecting phase in the second embodiment. Specifically, in the generation of the refined ranking information, information indicating the relationship between configuration items included in the computer system (e.g., logical dependency or physical connection relation) is learnt and used. Then, a detection server in the third embodiment outputs the generated refined ranking information.

The third embodiment is particularly preferable for an environment including a plurality of portions that are the same as each other or are similar to each other in the computer system. This is because, in the third embodiment, the refined ranking information that is useful for preventing a failure that may occur in a portion of the computer system may be obtained from information that is learnt according to a failure that has occurred in the past in another portion that is the same as or similar to that portion.

For example, the third embodiment may be applied to a large-scale computer system provided in a data center in order to provide an infrastructure in a cloud environment. The large-scale computer system as described above includes a large number of physical servers. In some cases, the computer system may further include a large number of storage devices, such as a disk array device. In this type of environment, for example, some physical servers are connected to one network device (e.g., an L2 switch). In addition, the respective physical servers are often virtualized, and a plurality of logical servers often run on the respective physical servers.

Accordingly, a network topology of a portion in the computer system (e.g., a broadcast domain) is often the same as or similar to a network topology of another portion. Similarly, a software configuration on a physical server is often the same as or similar to a software configuration on another physical server. Namely, the large-scale computer system as described above often includes a plurality of portions that are the same as or similar to each other. Accordingly, it is preferable that the third embodiment be applied to this type of large-scale computer system.

FIG. 8 illustrates the learning of relation information in the third embodiment. In an example in FIG. 8, assume that a message M21 is output at the time t21, a message M22 is output at the time t22, and a message M23 is output at the time t23. In addition, assume that, in a window which ends at the time t23, only the messages M21, M22, and M23 are included.

Also assume that an occurrence of a failure #39 is predicted according to a message pattern 601, including the messages M21, M22, and M23. Namely, assume that the message pattern 601 is detected as a predictive pattern of the failure #39. Further, assume that at the subsequent time t24, a message M24 reporting the actual occurrence of the failure #39 is output. In FIG. 8, IP addresses of configuration items that are the respective senders of the messages M21, M22, M23, and M24 are illustrated as “X”, “Z”, “W”, and “Y”, respectively.

From the actual occurrence of the failure #39 at the time t24, it is proved that the prediction at the time t23 is correct. Namely, it is proved at the time t24 that the message pattern 601 detected at the time t23 is a correct predictive pattern. Accordingly, in the third embodiment, the relation between a configuration item of a sender of each of the messages in the predictive pattern that is proved to be correct and a configuration item in which a failure has occurred is learnt at the time t24 (or later).

In FIG. 8, as an example, the relation between seventeen configuration items among a plurality of configuration items included in a computer system is illustrated in a form of a graph 602. In FIGS. 8-9, configuration information indicating the relation between the configuration items is illustrated in a form of a graph in order to assist understanding. However, a specific data format of the configuration information may vary according to an embodiment.

The graph 602 includes seventeen nodes N1-N17 indicating the seventeen configuration items. Hereinafter, for simplicity of description, a configuration item represented by a node Ni is also sometimes referred to simply as a “node Ni” (1≦i).

The nodes N1-N6 belong to a guest OS layer. IP addresses of configuration items that are represented by the nodes N1, N2, N3, and N4 are “X”, “Y”, “Z”, and “W”, respectively. The guest OS layer is one of the logical server layers.

In the examples in FIGS. 8-9, a set including a guest OS and all applications that run on the guest OS is treated as one configuration item in the guest OS layer. Hereinafter, for simplicity of description, a configuration item represented by, for example, a node N1 (namely, a configuration item including applications) is sometimes referred to simply as a “guest OS”.

In the examples in FIGS. 8-9, all of the senders of messages are configuration items in the guest OS layer, but this is accidental. A configuration item in another layer, of course, outputs a message.

The nodes N7-N10 belong to a host OS layer. The host OS layer is also one of the logical server layers.

In the examples in FIGS. 8-9, a set including a hypervisor and a host OS that runs on the hypervisor is treated as one configuration item in the host OS layer. Hereinafter, for simplicity of description, a configuration item represented by, for example, the node N7 is sometimes referred to simply as a “host OS”.

The nodes N11-N14 belong to a physical server layer. The nodes N15-N16 belong to an L2 switch layer, and the node N17 belongs to an L3 switch layer.

According to the graph 602, two L2 switches represented by the nodes N15 and N16 are connected to an L3 switch represented by the node N17 (for example, the L3 switch in FIG. 3). In the graph 602, direct and physical connection relation between network devices as described above is represented by an edge between two nodes.

According to the graph 602, two physical servers represented by the nodes N11 and N12 (for example, the physical servers 240 and 250 in FIG. 3) are connected to an L2 switch represented by the node N15. In addition, two physical servers represented by the nodes N13 and N14 (for example, the physical servers 260 and 270 in FIG. 3) are connected to an L2 switch represented by the node N16.

In the graph 602, direct and physical connection relation between a network device and a physical server as described above is also represented by an edge between two nodes. In addition, for example, a path from the node N11 through the node N15 to the node N17 indicates indirect connection relation between a physical server and an L3 switch.

Further, according to the graph 602, a host OS presented by the node N7 (for example, the host OS 242 in FIG. 3) runs on a physical server represented by the node N11 (for example, the physical server 240 in FIG. 3). In addition, guest OSs represented by the nodes N1 and N2 (for example, the guest OSs 243 and 244 in FIG. 3) use a function of the host OS represented by the node N7. In the graph 602, logical dependency between hardware and software or logical dependency between two pieces of software as described above are also presented by an edge between two nodes.

In addition, according to the graph 602, a host OS represented by the node N8 (for example, the host OS 252 in FIG. 3) runs on a physical server represented by the node N12 (for example, the physical server 250 in FIG. 3). Further, guest OSs represented by the nodes N3 and N4 (for example, the guest OSs 253 and 254 in FIG. 3) use a function of the host OS represented by the node N8.

According to the graph 602, a host OS represented by the node N9 (for example, the host OS 262 in FIG. 3) runs on a physical server represented by the node N13 (for example, the physical server 260 in FIG. 3). In addition, a guest OS represented by the node N5 (for example, the guest OS 263 in FIG. 3) uses a function of the host OS represented by the node N9.

Further, according to the graph 602, a host OS represented by the node N10 (for example, the guest OS 272 in FIG. 3) runs on a physical server represented by the node N14 (for example, the physical server 270 in FIG. 3). In addition, a guest OS represented by the node N6 (for example, the guest OS 273 in FIG. 3) uses a function of the host OS represented by the node N10.

The detection server in the third embodiment learns connection information by using, for example, configuration information represented by the graph 602 as described above. Specifically, when the detection server recognizes that the detected predictive pattern is correct, the detection server maps the respective messages in the predictive pattern and a message reporting a failure in the graph 602.

For example, in the example in FIG. 8, a configuration item of a sender of the message M21 is identified by the IP address “X”, and is represented by the node N1. In addition, it is proved at the time t24 that the message pattern 601 is a correct predictive pattern. Accordingly, the detection server maps the message M21 in the node N1. Similarly, the detection server maps the message M22 in the node N3, and maps the message M23 in the node N4.

A configuration item in which a failure #39 occurs at the time t24 (namely, a sender of the message M24 that reports the occurrence of the failure #39) is identified by the IP address “Y”, and is represented by the node N2. Therefore, the detection server maps the message M24 in the node N2.

Then, the detection server learns relation between a node in which a message in a predictive pattern is mapped and a node in which a message reporting a failure occurrence is mapped. The relation between the two nodes is uniquely represented by a shortest path between the two nodes. Therefore, in the third embodiment, the shortest path between the two nodes is learnt as relation information indicating relation between configuration items that are respectively represented by the two nodes. Specifically, in the example in FIG. 8, the detection server learns paths P1-P3.

The path P1 indicates relation between the configuration item of the sender of the message M21 and the configuration item in which the failure #39 has occurred. Specifically, the path P1 is a path from the node N1 through the node N7 to the node N2. Namely, the path P1 indicates that a sender of a message of the type “1”, which is used for a correct prediction, is another guest OS that uses a function of a host OS whose function is used by the guest OS in which the predicted failure #39 has actually occurred.

The path P2 indicates relation between the configuration item of the sender of the message M22 and the configuration item in which the failure #39 has occurred. Specifically, the path P2 is a path from the node N3 through the nodes N8, N12, N15, N11, and N7 to the node N2. Namely, the path P2 indicates that a sender of a message of the type “2”, which is used for a correct prediction, is a guest OS on another physical server that is connected to a physical server on which the guest OS in which the predicted failure #39 has actually occurred runs through the L2 switch.

The path P3 indicates relation between a configuration item of a sender of the message M23 and the configuration item in which the failure #39 has occurred. Specifically, the path P3 is a path from the node N4 through the nodes N8, N12, N15, N11, and N7 to the node N2. Namely, the path P3 indicates that a sender of a message of the type “3”, which is used for a correct prediction, is a guest OS on another physical server that is connected to a physical server on which the guest OS in which the predicted failure #39 has actually occurred runs through the L2 switch.

There may be a plurality of paths that connect two nodes. For example, as a path from the node N1 to the node N2, for example, a path that starts at the node N1, passes the nodes N7 and N11, returns to the node N7, and leads to the node N2 exists. However, this path includes a loop, and therefore, the path is not the shortest. Such a non-shortest path is not used for relation information indicating relation between the nodes N1 and N2.

The detection server can recognize a shortest path by using a known algorithm, such as the Warshall-Floyd algorithm.

The detection server in the third embodiment uses relation information that is learnt in response to the actual occurrence of a failure as described above for refining ranking information at the time of a future prediction of an occurrence of the same type of failure. Specifically, when the detection server in the third embodiment predicts an occurrence of some type of failure, the detection server in the third embodiment first generates ranking information similarly to the detection server 400 in the second embodiment. Then, the detection server in the third embodiment generates refined ranking information according to the generated ranking information and the learnt relation information.

FIG. 9 illustrates the refinement of the ranking in the third embodiment. FIG. 9 illustrates a case in which, after the paths P1-P3 in FIG. 8 are learnt, messages M31-M33 are output, and an occurrence of a failure #39 is predicted from a message pattern including the messages M31-M33.

Assume that the type of the message M31 is “3”, the type of the message M32 is “2”, and the type of the message M33 is “1”. In addition, only the messages M31-M33 are included in a window used for the prediction of the failure #39.

Here, assume that at least ten configuration items illustrated in FIG. 9 are included in a computer system, in addition to the seventeen configuration items illustrated in FIG. 8. In FIG. 9, relation between the ten configuration items is illustrated in a form of a graph 603.

Specifically, the graph 603 includes ten nodes N21-N30 indicating the ten configuration items. The nodes N21-N25 belong to a guest OS layer. IP addresses of the respective configuration items represented by the nodes N21-N25 are represented by characters “A”, “B”, “C”, “D”, and “E”, for convenience. Hereinafter, for convenience of description, for example, the IP address A is 172.16.1.2, the IP address B is 10.0.7.6, the IP address C is 10.0.0.1, the IP address D is 10.0.0.10, and the IP address E is 10.0.0.3.

The nodes N26-N27 belong to a host OS layer. The nodes N28-N29 belong to a physical server layer. The node N30 belongs to an L2 switch layer. An L3 switch layer is omitted in the graph 603.

According to the graph 603, two physical servers represented by the nodes N28 and N29 are connected to an L2 switch represented by the node N30.

According to the graph 603, a host OS represented by the node N26 runs on a physical server represented by the node N28. In addition, three guest OSs represented by the nodes N21, N22, and N23 respectively use a function of the host OS represented by the node N26.

Further, according to the graph 603, a host OS represented by the node N27 runs on a physical server represented by the node N29. In addition, two guest OSs represented by the nodes N24 and N25 respectively use a function of the host OS represented by the node N27.

Here, assume that a sender of the message M31 is the guest OS represented by the node N21 (namely, a configuration item that is identified by the IP address A (172.16.1.2)). In addition, assume that a sender of the message M32 is the guest OS represented by the node N23 (namely, a configuration item that is identified by the IP address C (10.0.0.1)). Further, assume that a sender of the message M33 is a guest OS represented by the node N25 (namely, a configuration item that is identified by the IP address E (10.0.0.3)).

As described above, assume that the occurrence of the failure #39 is predicted from the message pattern including the messages M31-M33. Accordingly, in this case, the detection server in the third embodiment calculates WF-IDF(f, n) for each of the three configuration items that are the senders of the messages M31-M33, similarly to the detection server 400 in the second embodiment. Then, the detection server generates ranking information 604 using the calculated three values. The format of the ranking information 604 is similar to that of the ranking information 305 in FIG. 4.

According to the ranking information 604, WF-IDF(39, 1), which is calculated for a configuration item that has output the message M33, is 2.0000, and is the largest among the three values. In addition, WF-IDF(39, 2), which is calculated for a configuration item that has output the message M32, is 0.0043. Similarly, WF-IDF(39, 3), which is calculated for a configuration item that has output the message M31, is also 0.0043. Therefore, the configuration item that is identified by the IP address E ranks as the first, and both of the two configuration items that are respectively identified by the IP addresses C and A rank as the second.

The detection server in the third embodiment generates refined ranking information 605 from the ranking information 604 using the learnt relation information (specifically, the paths P1-P3 in FIG. 8). Here, as may be seen from the examples of the ranking information 604 and the refined ranking information 605 in FIG. 9, there are the following differences between the ranking information and the refined ranking information.
In the ranking information, a score is given to all of the configuration items that output at least one message that is included in a message pattern used for a failure prediction
In the ranking information, no scores are given to a configuration item that does not output any messages that are included in the message pattern used for the failure prediction.
In the refined ranking information, a score may be given to a configuration item that does not output any messages that are included in the message pattern used for the failure prediction.
In the refined ranking information, no scores may be given to a configuration item that outputs at least one message that is included in the message pattern used for the failure prediction.

Described below in detail is a method in which the detection server generates the refined ranking information 605.

The type of the message M31 is “3”, and relation information that is learnt with respect to the message type “3” is the path P3 in FIG. 8. Therefore, the detection server retrieves a configuration item in which relation equivalent to relation indicated by the path P3 is established with the sender of the message M31 (hereinafter sometimes referred to as a “relevant configuration item”). Specifically, in the graph 603, the detection server traverses a path that starts at the node N21 representing the sender of the message M31 and is topologically similar to the path P3. Then, the detection server recognizes a configuration item that is represented by an endpoint node of the path, which is similar to the path P3, as a relevant configuration item for the message M31.

In the example in FIG. 9, there are a plurality of paths that are similar to the path P3. However, there are only two paths that satisfy the conditions where a path that is similar to the path P3 is a shortest path between the node N21, which is a start point, and an endpoint of the path that is similar to the path P3 (hereinafter referred to as “shortest path conditions”). The relevant configuration item for the message M31 is, more accurately, a configuration item that is represented by an end point node of a path satisfying the shortest path conditions, from among paths that are similar to the path P3.

As illustrated in FIG. 8, the path P3 starts at a node in the guest OS layer. Then, the path P3 passes a node in the host OS layer, a node in the physical server layer, a node in the L2 switch layer, a node in the physical server layer, and a node in the host OS layer, and leads to a node in the guest OS layer. In the graph 603, there are a plurality of paths that start at the node N21 and pass nodes in various layers in the same order as the path P3 described above. However, there are only two paths that satisfy the shortest path conditions.

For example, a path from the node N21 through the nodes N26, N28, N30, N28, and N26 to the node N22 is similar to the path P3, but does not satisfy the shortest path conditions. In contrast, both of the two paths described below are similar to the path P3 and satisfy the shortest path conditions.
A path from the node N21 through the nodes N26, N28, N30, N29, and N27 to the node N24 (this path is illustrated as a path P13 in FIG. 9)
A path from the node N21 through the nodes N26, N28, N30, N29, and N27 to the node N25

Accordingly, the detection server recognizes two configuration items represented by the nodes N24 and N25 as a relevant configuration item for the message M31 of the type “3”. Namely, the relevant configuration item for the message M31 is two configuration items that are respectively identified by the IP addresses D and E.

The type of the message M32 is “2”, and relation information that is learnt with respect to the message type “2” is the path P2 in FIG. 8. Therefore, in the graph 603, the detection server traverses a path that starts at the node N23 representing a sender of the message M32, is topologically similar to the path P2, and satisfies the shortest path conditions. The detection server recognizes a configuration item represented by an end point node of the traversed path as a relevant configuration item for the message M32. Specifically, the following two paths are given as a path that starts at the node N23, is similar to the path P2, and satisfies the shortest path conditions.
A path from the node N23 through the nodes N26, N28, N30, N29, and N27 to the node N24 (this path is illustrated as a path P12 in FIG. 9)
A path from the node N23 through the nodes N26, N28, N30, N29, and N27 to the node N25

Accordingly, the detection server recognizes two configuration items represented by the nodes N24 and N25 as a relevant configuration item for the message M32 of the type “2”. Namely, the relevant configuration item for the message M32 is also the two configuration items that are respectively identified by the IP addresses D and E.

The type of the message M33 is “1”, and relation information that is learnt with respect to the message type “1” is a path P1 in FIG. 8. Accordingly, in the graph 603, the detection server traverses a path that starts at the node N25, which represents a sender of the message M33, is topologically similar to the path P1, and satisfies the shortest path conditions.

Here, there are two paths that start at the node N25 and are similar to the path P1. One is a path that starts at the node N25, passes the node N27, and returns to the node N25. However, this path does not satisfy the shortest path conditions. The other is a path P11, which starts at the node N25, passes the node N27, and leads to the node N24. The path P11 satisfies the shortest path conditions.

Accordingly, the detection server recognizes a configuration item that is represented by an end point node N24 of the path P11 as a relevant configuration item for the message M33 of the type “1”.

In view of the foregoing, the configuration item that is identified by the IP address D is a relevant configuration item for the message M31, a relevant configuration item for the message M32, and a relevant configuration item for the message M33. Therefore, the detection server determines a maximum value from among WF-IDF(39, 3), WF-IDF(39, 2), and WF-IDF(39, 1), which are respectively calculated with respect to the senders of the messages M31, M32, and M33, to be a score of the configuration item that is identified by the IP address D.

Here, according to the ranking information 604 in FIG. 9, WF-IDF(39, 3)=0.0043, WF-IDF(39, 2)=0.0043, and WF-IDF(39, 1)=2.0000. Therefore, the score of the configuration item that is identified by the IP address D is 2.0000.

The configuration item that is identified by the IP address E is a relevant configuration item for the message M31 and a relevant configuration item for the message M32. Therefore, the detection server determines a maximum value among WF-IDF (39, 3) and WF-IDF (39, 2), which are respectively calculated with respect to the senders of the messages M31 and M32, to be a score of the configuration item that is identified by the IP address E. Namely, the score of the configuration item that is identified by the IP address E is 0.0043.

A configuration item other than the two configuration items that are identified by the IP address D and E is not a relevant configuration item for any of the messages M31, M32, and M33. Therefore, the detection server determines the ranking of the two configuration items above according to the scores that are determined with respect to the two configuration items above. Namely, the configuration item to which a score of 2.0000 is given (i.e., the configuration item that is identified by the IP address D) ranks as the first, and the configuration item to which a score of 0.0043 is given (i.e., the configuration item that is identified by the IP address E) ranks as the second.

In the refined ranking information 605, the ranking and score determined as described above is associated with an IP address along with a message type that is the basis for providing a score.

In the example above, no messages are accidentally output from the configuration item that is identified by the IP address D in a window used for the prediction of the failure #39. In spite of this, the configuration item that is identified by the IP address D is judged to rank the first. As described above, in the generation of the refined ranking information 605, relation equivalent to relation between a sender of a message in the message pattern 601, which is a correct predictive pattern, and a configuration item in which a failure has actually occurred at the time t24, is used.

The refined ranking information 605 generated as described above is based on not only statistics, such as WF-IDF(f, n), but also relation information, and therefore, the refined ranking information 605 is more reliable than the ranking information 604. Accordingly, in the third embodiment, the detection server can provide information that suggests a configuration item against which it is preferable to take measures for preventing a failure occurrence, with higher reliability.

In addition, the third embodiment, which uses the relation information as described above, is particularly preferable to a large-scale computer system including a plurality of portions that are the same as or similar to each other (for example, a portion illustrated by the graph 602 and a portion illustrated by the graph 603). This is because, by using the relation information, a data sparseness problem regarding the learning of a predictive pattern is reduced, and the reliability of information presented by the detection server is enhanced.

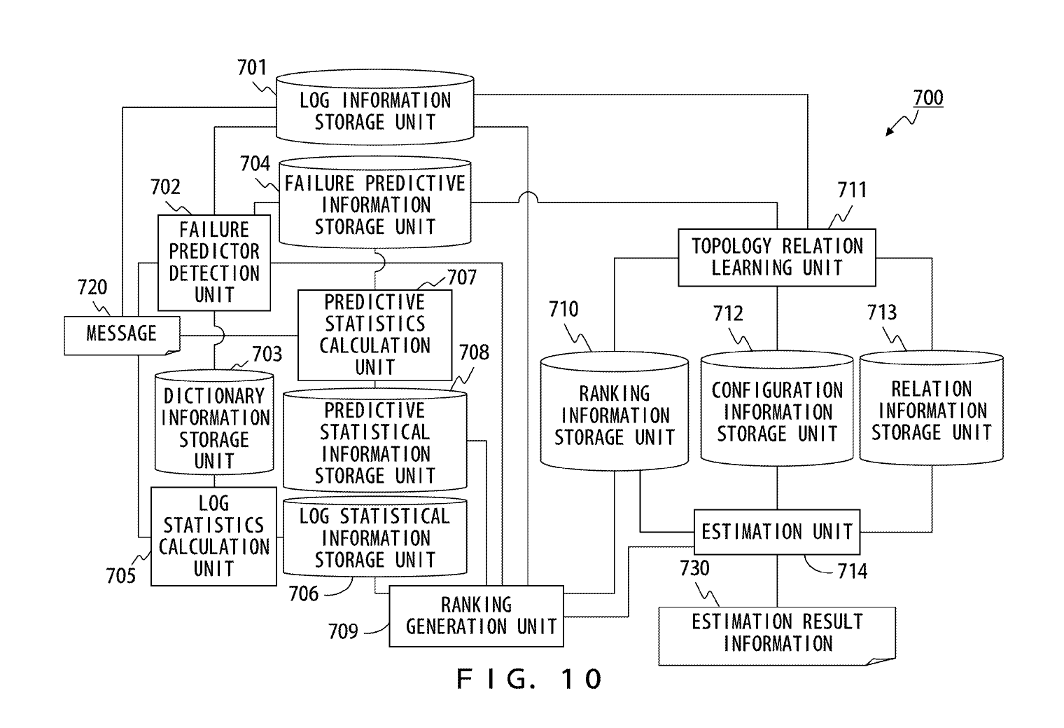

Described next are the further details of the third embodiment described with reference to FIGS. 8-9, with reference to FIGS. 10-14.

FIG. 10 is a block diagram of a detection server 700 in the third embodiment. The detection server 700 receives a message 720 as an input from various configuration items in a computer system, and outputs estimation result information 730. Specifically, the estimation result information 730 may be, for example, the refined ranking information 605 in FIG. 9.

The detection server 700 includes some components that are similar to components in the detection server 400 in the second embodiment. Specifically, the detection server 700 includes a log information storage unit 701, a failure predictor detection unit 702, a dictionary information storage unit 703, and a failure predictor information storage unit 704. In addition, the detection server 700 includes a log statistics calculation unit 705, a log statistical information storage unit 706, a predictive statistics calculation unit 707, a predictive statistical information storage unit 708, a ranking generation unit 709, and a ranking information storage unit 710.

Further, the detection server 700 also includes some components that do not exist in the detection server 400. Specifically, the detection server 700 further includes a topology relation learning unit 711, a configuration information storage unit 712, a relation information storage unit 713, and an estimation unit 714.

In the log information storage unit 701, a message 720 is stored. The log information storage unit 701, the failure predictor detection unit 702, the dictionary information storage unit 703, the failure predictor information storage unit 704, the log statistics calculation unit 705, the log statistical information storage unit 706, the predictive statistics calculation unit 707, and the predictive statistical information storage unit 708 are similar to the respective components in the second embodiment.

The ranking generation unit 709 generates ranking information (e.g., the ranking information 604 in FIG. 9) similarly to the ranking generation unit 409 in the second embodiment, and stores the generated ranking information in the ranking information storage unit 710. However, in the third embodiment, refined ranking information that is obtained from ranking information generated by the ranking generation unit 709 (e.g., the refined ranking information 605 in FIG. 9), not the ranking information mentioned above, is output as the estimation result information 730.

The ranking information storage unit 710 stores the ranking information similarly to the ranking information storage unit 410 in the second embodiment. Further, the ranking information storage unit 710 stores the refined ranking information.

As illustrated in FIG. 8, when a predictive pattern that is detected by the failure predictor detection unit 702 is proved to be correct, the topology relation learning unit 711 learns relation information between a sender of each message included in the correct predictive pattern and a configuration item in which a failure has actually occurred. Then, the topology relation learning unit 711 stores the learnt relation information in the relation information storage unit 713. Specifically, the topology relation learning unit 711 in the third embodiment refers to the log information storage unit 701, the failure predictor information storage unit 704, the ranking information storage unit 710, and the configuration information storage unit 712, and learns the relation information.

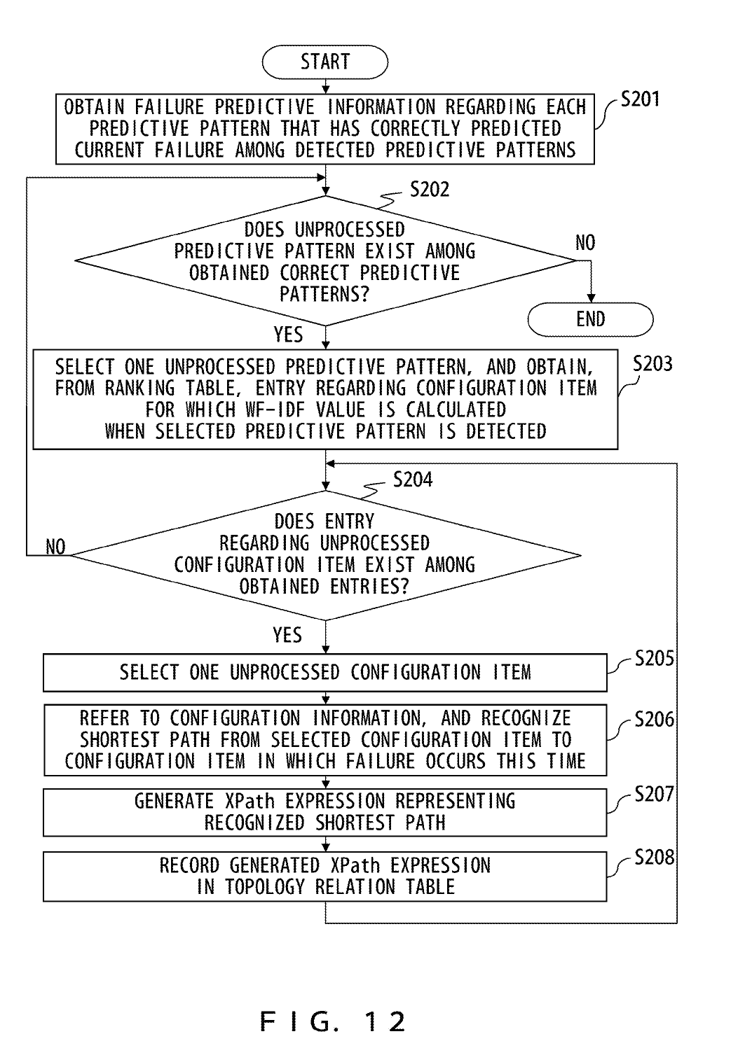

Depending on the embodiment, the topology relation learning unit 711 does not necessarily need to refer to the log information storage unit 701 and the ranking information storage unit 710. For example, when an IP address of a sender of each message included in the detected predictive pattern is stored in the failure predictor information storage unit 704, the topology relation learning unit 711 may refer to the failure predictor information storage unit 704 and the configuration information storage unit 712, and learn the relation information. An example of detailed procedures of the learning by the topology relation learning unit 711 is described later, along with FIG. 12.

In the configuration information storage unit 712, configuration information representing relation between a plurality of configuration items in a computer system is stored. When a configuration of the computer system is changed, the configuration information is changed accordingly. For example, when the addition of a new configuration item, the deletion of an existing configuration item, migration, or the like is performed, the configuration information is changed. The configuration information storage unit 712 may be a known Configuration Management Database (CMDB).

Both the graph 602 in FIG. 8 and the graph 603 in FIG. 9 virtually represent a portion of the configuration information in a graph form for convenience. An actual data format of the configuration information in the configuration information storage unit 712 may vary according to an embodiment. For example, a table format may be used, or a format using a predetermined language such as an XML (Extensible Markup Language) may be used.

In the configuration information in the third embodiment, each configuration item is identified by an IP address that is identification information. Therefore, the estimation unit 714 can recognize an IP address of a configuration item of an end point of a path by searching for an end point of a path as illustrated in FIG. 9, for example.

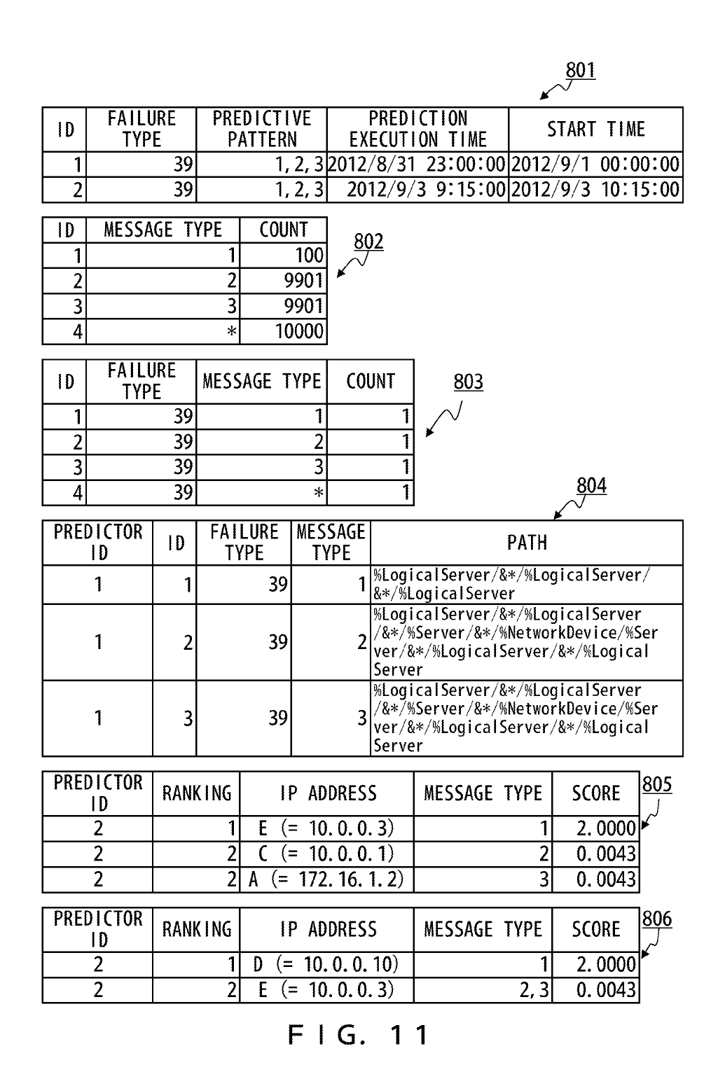

In the relation information storage unit 713, relation information learnt by the topology relation learning unit 711 is stored. The details of the relation information storage unit 713 are described later, along with FIG. 11.

The estimation unit 714 generates the refined ranking information using the ranking information generated by the ranking generation unit 709, the learnt relation information stored in the relation information storage unit 713, and the configuration information stored in the configuration information storage unit 712. In other words, the estimation unit 714 estimates a configuration item that is highly relevant to a failure predicted by the failure predictor detection unit 702 (i.e., a configuration item with a high probability of a failure occurrence) according to relation between configuration items in the computer system. An estimation result is the refined ranking information. In addition, a configuration item that is estimated to be highly relevant to the failure is a configuration item having a high probability of obtaining an effect of preventing a failure occurrence by taking certain measures, in some cases.

A failure may be caused directly or indirectly by another failure. Therefore, in some cases, it may be useful to take measures against another configuration item in which another failure, which is a cause of a failure, is likely to occur, not against a configuration item that is estimated to have a high probability of an occurrence of the failure. However, even in such cases, a system administrator or the like can obtain a suggestion regarding which configuration item it would be useful to take measures against in order to prevent a failure occurrence, from the refined ranking information. This is because the refined ranking information indicates which configuration item has a high probability of the occurrence of the failure and therefore the refined ranking information is useful for narrowing down candidates for a configuration item which measures will be taken against.

The estimation unit 714 outputs the generated refined ranking information (e.g., the refined ranking information 605 in FIG. 9) as the estimation result information 730. For example, the estimation unit 714 may output the refined ranking information as the estimation result information 730 on a display or to the ranking information storage unit 710. The estimation unit 714 may transmit an electronic mail or an instant message including the refined ranking information to a system administrator. In some embodiments, the estimation unit 714 may refer to log information.

The detection server 700 in FIG. 10 may specifically be the computer 100 in FIG. 2. When the detection server 700 is realized by the computer 100, FIG. 10 and FIG. 2 correspond to each other as described below.

The detection server 700 receives a message 720 through the communication interface 103. The detection server 700 may output the estimation result information 730 to the output device 105, to the storage device 106, or to the storage medium 110 through the driving device 107. Of course, the detection server 700 may transmit (namely, output) the estimation result information 730 through the communication interface 103 and the network 120.

The log information storage unit 701, the dictionary information storage unit 703, the failure predictor information storage unit 704, the log statistical information storage unit 706, the predictive statistical information storage unit 708, the ranking information storage unit 710, the configuration information storage unit 712, and the relation information storage unit 713 may be realized by the storage device 106. The failure predictor detection unit 702, the log statistics calculation unit 705, the predictive statistics calculation unit 707, the ranking generation unit 709, the topology relation learning unit 711, and the estimation unit 714 may be realized by the CPU 101 that executes a program.

Further, the detection server 700 in FIG. 10 may be the computer 200 in FIG. 3. In this case, the message 720 is output from various configuration items in the computer system 230, and is received by the computer 200 as the detection server 700 through the network 210. In addition, a system administrator in the computer system 230 refers to the estimation result information 730, which is output from the detection server 700, determines which configuration item in the computer system 230 measures are taken against, and performs appropriate measures.

Described next is a specific example of information stored in various storage units in FIG. 10, with reference to FIG. 11. FIG. 11 illustrates examples of various tables that are used in the third embodiment.

Tables in the log information storage unit 701 and the dictionary information storage unit 703 are omitted in FIG. 11. A table similar to, for example, the log table 501 in FIG. 6 may be stored in the log information storage unit 701. Further, tables similar to the message dictionary table 502 and the pattern dictionary table 503 in FIG. 6 may be stored in the dictionary information storage unit 703.

A failure predictor table 801 in FIG. 11 is an example of information stored in the failure predictor information storage unit 704. Various values illustrated in the failure predictor table 801 are different from various values illustrated in the failure predictor table 504 in FIG. 6, but the format of the failure predictor table 801 is similar to that of the failure predictor table 504.

Similarly to the failure predictor table 504, the failure predictor table 801 may further include a field indicating an end time of a predicted failure. In some embodiments, in the failure predictor table 801, not only a type of each message that is included in a predictive pattern detected by the failure predictor detection unit 702 but also an IP address of a sender of each message may be further stored.

In the failure predictor table 801 in FIG. 11, a result of a prediction that is performed according to the message pattern 601 at the time t23 in FIG. 8 is stored in an entry having an ID of “1”. A result of a prediction illustrated in FIG. 9 is stored in an entry having an ID of “2”.

The log statistics table 802 is an example of information stored in the log statistical information storage unit 706. Various values illustrated in the log statistics table 802 are different from various values illustrated in the log statistics table 505 in FIG. 6, but a format of the log statistics table 802 is similar to that of the log statistics table 505.

FIG. 11 illustrates four entries in the log statistics table 802 at the time of the generation of the ranking information 604 in FIG. 9. The log statistics table 802 may further include other entries corresponding to message types other than “1”-“3”, but such entries are omitted in FIG. 11.

The predictive statistics table 803 is an example of information stored in the predictive statistical information storage unit 708. Various values illustrated in the predictive statistics table 803 are different from various values illustrated in the predictive statistics table 506 in FIG. 6, but a format of the predictive statistics table 803 is similar to that of the predictive statistics table 506.

FIG. 11 illustrates four entries in the predictive statistics table 803 at the time of the generation of the ranking information 604 in FIG. 9. In other words, FIG. 11 illustrates the contents of the learning in response to the occurrence of the failure #39 at the time t24 in FIG. 8. The predictive statistics table 803 indicates that it is only once (i.e., only in a prediction at the time t23) that the failure #39 has been predicted correctly within a prediction target period which ends at the time t24. The predictive statistics table 803 may further include other entries corresponding to failure types other than “39”, but such entries are omitted in FIG. 11.

The topology relation table 804 is an example of relation information stored in the relation information storage unit 713. When a failure occurrence is correctly predicted, and a predictive pattern detected in the correct prediction includes P messages (1≦P), P entries are added to the topology relation table 804 by the topology relation learning unit 711. The respective entries in the topology relation table 804 may include the five fields described below, for example.
ID that identifies an entry representing the correct prediction above in the failure predictor table 801 (hereinafter referred to as a “predictor ID”)
ID that identifies each entry in the topology relation table 804
Type of a correctly predicted failure described above
Type of each message in a message pattern used in the correct prediction above (i.e., a detected predictive pattern)
Path indicating relation between a configuration item of a sender that outputs a message represented by the message type of the entry among messages included in the predictive pattern, and a configuration item in which the correctly predicted failure above has occurred

In the third embodiment, the path described above in the topology relation table 804 is specifically a path from a node of a configuration item of a sender to a node of a configuration item in which a failure has occurred in a graph such as the graph 602 in FIG. 8. In addition, in the third embodiment, a path indicating relation between two configuration items as described above is presented by, specifically, the XPath format. The representation of a path in the XPath format is used in a query in some type of FCMDB (federated CMDB), and therefore, the detailed descriptions are omitted here. In the aspect of the association of the third embodiment, the outline of the representation of a path in the XPath format is as described below.

Paths of three entries in the topology relation table 804 respectively represent the paths P1, P2, and P3 in FIG. 8. For example, an XPath expression in the second entry represents the path P2. As illustrated in FIG. 8, the path P2 is a sequence of nodes and edges as described below.
The node N3 (i.e., anode indicating a sender of a message of the type “2”) in a logical server layer (specifically, a guest OS layer)
The edge from the node N3 to a node N8 in a logical server layer (specifically, a host OS layer)
Node N8
The edge from the node N8 to a node N12 in a physical server layer
Node N12
The edge from the node N12 to a node N15 in a network device layer (specifically, an L2 switch layer)
Node N15
The edge from the node N15 to a node N11 in the physical server layer
Node N11
The edge from the node N11 to a node N7 in a logical server layer (specifically, the host OS layer)
Node N7
The edge from the node N7 to a node N2 (i.e., a node indicating a configuration item in which the failure #39 has actually occurred) in a logical server layer (specifically, the guest OS layer)
Node N2

As described with respect to FIG. 9, an XPath expression in the topology relation table 804 is used for, specifically, the retrieval of a topologically similar path. Therefore, in the third embodiment, an XPath expression indicating nodes in which layers in what order the path P2 passes, not information that specifically indicates the path P2, is used.

For example, an XPath expression in a second entry in the topology relation table 804 indicates the following. Only relation information in a somewhat generalized format, which is represented by such an XPath expression, is sufficient for the retrieval of a path similar to the path P2.
A first node on the path (i.e., a starting point of the path) is a node in a logical server layer.
A second node on the path is a node in a logical server layer.
A third node on the path is a node in a physical server layer.
A fourth node on the path is a node in a network device layer.
A fifth node on the path is a node in a physical server layer.
A sixth node on the path is a node in a logical server layer.
A seventh node on the path is a node in a logical server layer, and the seventh node is an end point.

Of course, in some embodiments, a path may be represented in a format other than XPath. An XPath expression is merely an example of data in a predetermined format for indicating relation between two configuration items.

The ranking table 805 is a table that is generated by the ranking generation unit 709 similarly to the ranking generation unit 409 in the second embodiment. Therefore, the format of the ranking table 805 is the same as the format of the ranking table 507 in FIG. 6.

In the ranking table 805 in FIG. 11, three entries corresponding to the ranking information 604 in FIG. 9 are illustrated. In addition, a predictor ID in each entry in the ranking table 805 is an ID that identifies a prediction that is a cause of the calculation of a score (i.e., WF-IDF(f, n)) of the entry, and is, specifically, an ID that identifies an entry in the failure predictor table 801.

For example, all of the predictor IDs of three entries illustrated in the ranking table 805 are “2”. Namely, the three entries correspond to ranking information that is generated in the prediction (i.e., the prediction in FIG. 9) of a second entry having an ID of “2” in the failure predictor table 801.

The refined ranking table 806 is a table that is generated by the estimation unit 714 according to the ranking table 805. A format of the refined ranking table 806 is the same as that of the ranking table 805. For example, two entries illustrated in the refined ranking table 806 correspond to the refined ranking information 605 in FIG. 9. The refined ranking information 605 is generated when a prediction that is identified by an ID of “2” in the failure predictor table 801 is performed. Therefore, both of the predictor IDs of the two entries in the refined ranking table 806 in FIG. 11 are “2”.

In the third embodiment, both the ranking table 805 and the refined ranking table 806 are stored in the ranking information storage unit 710. In the ranking table 805 in FIG. 11, only three entries having a predictor ID of “2” are illustrated; however, the ranking table 805 in the ranking information storage unit 710 includes three entries having a predictor ID of “1”. Namely, in the ranking table 805 in the ranking information storage unit 710, not only ranking information that is obtained according to the prediction in FIG. 9 but also ranking information that is obtained according to the prediction at the time t23 in FIG. 8 is stored.

Next, processes performed by the detection sever 700 are described further in detail. Similarly to the second embodiment, among various processes performed by the detection server 700, the storage of the message 720 in the log information storage unit 701, the learning of the pattern dictionary table 503, and the detection of a failure predictor by the failure predictor detection unit 702 may be similar to known processes. In addition, the detection server 700 performs processes similar to the processes in FIG. 7, but steps S103 and S113 in FIG. 7 are varied in the third embodiment.

Specifically, in the third embodiment, step S103 in FIG. 7 is varied as described below.
The predictive statistics calculation unit 707 updates the predictive statistical information storage unit 708 in a manner similar to step S103 in the second embodiment.
The topology relation learning unit 711 learns relation information as illustrated in FIG. 8 according to the flowchart in FIG. 12.

In addition, in the third embodiment, step S113 in FIG. 7 is varied as described below.
The ranking generation unit 709 sorts entries in the ranking table 805 similarly to step S113 in the second embodiment, and ranks the respective entries. In addition, the ranking generation unit 709 adds the respective entries in the ranking table 805 to the ranking information storage unit 710.
Further, the ranking generation unit 709 outputs the ranking table 805 to the estimation unit 714. When this happens, the ranking generation unit 709 also reports the type of a failure predicted by the failure predictor detection unit 702 to the estimation unit 714. The type of the failure predicted by the failure predictor detection unit 702 has already been reported from the failure predictor detection unit 702 to the ranking generation unit 709 in step S101.
The estimation unit 714 recognizes a message pattern used for the prediction according to a message type filed in the ranking table 805 which is received from the ranking generation unit 709. For example, from the ranking table 805 in FIG. 11, a message pattern [1, 2, 3] is recognized.
Then, the estimation unit 714 retrieves relation information that has already been learnt in correspondence with a combination of the recognized message pattern and the type of a failure reported from the ranking generation unit 709 in the relation information storage unit 713.
As a result of retrieval, when the learnt relation information is found, the estimation unit 714 generates and outputs refined ranking information (e.g., the refined ranking table 806 in FIG. 11) as illustrated in FIG. 9.
As a result of retrieval, when the learnt relation information is not found, the estimation unit 714 may output the received ranking table 805 as the message 720.

In some embodiments, as a result of retrieval, when the learnt relation information is not found, the estimation unit 714 may perform processes described below.

The estimation unit 714 may retrieve relation information that has already been learnt in correspondence with a combination of a message pattern including a message pattern that is recognized from the received ranking table 805 and the type of a failure that is reported by the ranking generation unit 709. Here, a case in which all of the messages included in a first message pattern are also included in a second message pattern is referred to as “a second message pattern includes a first message pattern”. For example, a message pattern [1, 2] is included in a message pattern [1, 2, 3, 4].

For example, there may be a case in which a failure #5 is predicted from the message pattern [1, 2] but relation information that is learnt in correspondence with a combination of the message pattern [1, 2] and the failure #5 does not exist yet. In this case, if there is relation information that has been learnt in correspondence with a combination of the message pattern [1, 2, 3, 4] and the failure #5, the estimation unit 714 may use the relation information. Namely, as a result of the re-retrieval for a combination of another message pattern including the message pattern [1, 2]and the failure #5, when relation information is not found, the estimation unit 714 may generate a refined ranking table from a ranking table according to a result of the re-retrieval. Then, the estimation unit 714 may output the generated refined ranking table as the estimation result information 730.

Alternatively, the estimation unit 714 may retrieve relation information that has already been learnt in correspondence with a combination of a message pattern that is similar to a message pattern recognized from the received ranking table 805 and the type of a failure reported by the ranking generation unit 709. For example, there may be a case in which the failure #5 is predicted from the message pattern [1, 2] but relation information that is learnt in correspondence with a combination of the message pattern [1, 2] and the failure #5 does not exist yet. In this case, the estimation unit 714 may retrieve relation information that is learnt in correspondence with, for example, a combination of a message pattern [1, 10] and the failure #5 or a combination of a message pattern [2, 18] and the failure #5. The criteria of whether two message patterns are similar may vary according to an embodiment, and/or message patterns similar to each other include at least one message of the same type.

FIG. 12 is a flowchart of a process in which the detection server 700 (specifically, the topology relation learning unit 711) learns relation information in the third embodiment. In the third embodiment, when a failure occurs, the topology relation learning unit 711 performs a process in FIG. 12.

The topology relation learning unit 711 may recognize a failure occurrence from the message 720 that the detection server 700 receives, or recognize the failure occurrence by monitoring an addition of an entry to the log information storage unit 701. Alternatively, the predictive statistics calculation unit 707, which performs the process of step S103 in FIG. 7 in reply to a failure occurrence, may report the failure occurrence to the topology relation learning unit 711. In any case, when some kind of failure occurs, the topology relation learning unit 711 starts the process in FIG. 12.

In step S201, the topology relation learning unit 711 obtains failure predictor information on each predictive pattern that correctly predicted the failure that occurred this time. In other words, the topology relation learning unit 711 obtains failure predictor information on each prediction that correctly predicted the failure that occurred this time from among predictions that have already been performed. Specifically, the topology relation learning unit 711 retrieves a prediction result that has been performed during a prediction target period having a length of T2 that precedes the current failure occurrence, from the failure predictor information storage unit 704. This retrieval is similar to the retrieval that is performed by the predictive statistics calculation unit 407 in step S103 of FIG. 7.

For example, when a failure #39 occurs at the time t24 in FIG. 8, the topology relation learning unit 711 starts to perform the process in FIG. 12. In the example in FIG. 8, assume that a difference between the time t24 and the time t23 does not exceed a length of T2. Therefore, when the topology relation learning unit 711 performs retrieval with reference to fields of a failure type and a prediction execution time in the failure predictor table 801, the topology relation learning unit 711 obtains a first entry in the failure predictor table 801 (i.e., an entry indicating a prediction result at the time t23). Obtaining the first entry as described above means that, regarding the failure #39 which has actually occurred at the time t24, a predictive pattern [1, 2, 3] which has been predicted at the time t23 (in an example in FIG. 11, 23:00, Aug. 31, 2012) is proven to be correct.

There may be a case in which an occurring failure has never been predicted correctly in the past within a prediction target period having a length of T2. There may be a case in which the occurring failure has been predicted correctly once in the past within the prediction target period having a length of T2, or a case in which the occurring failure has been predicted correctly two or more times. Therefore, the number of entries that are obtained from the failure predictor information storage unit 704 in step S201 may be 0, 1, or 2 or more.

Next, in step S202, the topology relation learning unit 711 judges whether there is an unprocessed predictive pattern among correct predictive patterns obtained in step S201. Namely, the topology relation learning unit 711 judges whether there is an entry that has not yet been selected as a target of the processes of step S203 and the following steps from among the entries obtained in step S201.

When no entries are obtained in step S201 or all of the entries obtained in step S201 have already been selected as a target of the processes of step S203 and the following steps, there is no unprocessed predictive pattern. Therefore, the learning of the relation information in FIG. 12 is finished.

In contrast, when one or more entries are obtained in step S201 and there is an entry that has not yet been selected as a target of the processes of step S203 and the following steps, there is an unprocessed predictive pattern. In this case, the topology relation learning unit 711 next selects one unprocessed predictive pattern in step S203. Namely, in step S203, the topology relation learning unit 711 selects one entry, which is obtained in step S201. Hereinafter, for convenience of description, a predictive pattern of an entry selected in step S203 is sometimes referred to as a “selected predictive pattern”.

Further, in step S203, the topology relation learning unit 711 obtains an entry for each of one or a plurality of configuration items for which a WF-IDF value is calculated when a selected predictive pattern is detected, from the ranking table 805 in the ranking information storage unit 710.

For example, when the topology relation learning unit 711 performs the processes in FIG. 12 in response to the occurrence of a failure #39 at the time t24 in FIG. 8, in step S201, an entry corresponding to a prediction at the time t23 is obtained. Namely, in this case, a first entry in the failure predictor table 801 is obtained in step S201, and is selected in step S203.

Then, in step S203, the topology relation learning unit 711 reads an ID of the first entry in the failure predictor table 801. The topology relation learning unit 711 retrieves the ranking table 805 in the ranking information storage unit 710 using a value of the read ID as a retrieval key. Although it is omitted in FIG. 11, the ranking table 805 has three entries that are added with respect to configuration items of the respective senders of messages M21, M22, and M23 corresponding to the prediction at the time t23 in FIG. 8.

Therefore, the topology relation learning unit 711 can obtain the three entries as a result of retrieval. Namely, the topology relation learning unit 711 obtains three entries that are added to the ranking table 805 in the prediction at the time t23 with respect to three configuration items that are identified by the IP addresses “X”, “Z”, and “W”.

Next, in step S 204, the topology relation learning unit 711 judges whether there remains an entry regarding an unprocessed configuration item among the entries obtained in step S203. Namely, the topology relation learning unit 711 judges whether there remains a configuration item whose relation information has not been learnt yet among configuration items that have output at least one message that is included in one predictive pattern that has been proved to be correct.

Specifically, when there remains an entry that has not been selected yet as a target of the processes of steps S205-S208 among entries that are obtained from the ranking table 805 in step S203, the learning process in FIG. 12 next proceeds to step S205. In contrast, when steps S205-S208 have already been performed with respect to all of the entries that are obtained from the ranking table 805 in step S203, the learning process in FIG. 12 returns to step S202.

Then, in step S205, the topology relation learning unit 711 selects one unprocessed configuration item. Namely, the topology relation learning unit 711 selects one unprocessed entry from among the entries obtained from the ranking table 805 in step S203 (note that one entry in the ranking table 805 corresponds to one configuration item). Hereinafter, for convenience of description, the configuration item selected in step S205 is also referred to as a “selected configuration item”.

Next, in step S206, the topology relation learning unit 711 refers to configuration information stored in the configuration information storage unit 712, and recognizes a shortest path from the selected configuration item to a configuration item in which a failure has occurred this time.

For example, assume that, as described above in step S204, three entries on three configuration items that are respectively identified by the IP addresses “X”, “Z”, and “W” in FIG. 8 are obtained from the ranking table 805 in the ranking information storage unit 710. Then, assume that, in step S205, an entry corresponding to the configuration item that is identified by the IP address “X” is selected. In addition, according to FIG. 8, a configuration item in which a failure #39 actually occurs at the time t24 is identified by the IP address “Y”. Accordingly, in this case, in step S206, the topology relation learning unit 711 refers to configuration information, and recognizes a path P1 in FIG. 8. It is obvious from FIG. 8 that the path P1 is a shortest path.

The configuration information may not only define a relation between configuration items as illustrated in a format of the graph 602 in FIG. 8 but also include information regarding a shortest path between two optional configuration items. For example, the detection server 700 may obtain the shortest path between the two optional configuration items by using a known algorithm, such as the Warshall-Floyd algorithm, beforehand. The shortest path that is proven beforehand as described above may be stored in the configuration information storage unit 712. In this case, the topology relation learning unit 711 can recognize a shortest path by only reading information of the stored shortest path. Of course, the topology relation learning unit 711 may dynamically retrieve a shortest path by using a known algorithm, such as Dijkstra's algorithm, in step S206.

In any case, after the topology relation learning unit 711 recognizes a shortest path, the topology relation learning unit 711 generates an XPath expression representing the recognized shortest path in step S207. For example, when the topology relation learning unit 711 recognizes the path P1 in FIG. 8 as a shortest path in step S206, the topology relation learning unit 711 generates an XPath expression as illustrated in the first entry in the topology relation table 804 in FIG. 11, in step S207.

Then, in the next step S208, the topology relation learning unit 711 records the generated XPath expression in the topology relation table 804. Specifically, the topology relation learning unit 711 adds the same number of new entries as the number of types that are stored in a message type field of an entry that is selected from the ranking table 805 in step S205, to the topology relation table 804.

For example, assume that three messages among messages included in a correct predictive pattern are output from one configuration item and an entry in the ranking table 805 with respect to the configuration item is selected in step S205. In this case, in step S208, three entries are added to the topology relation table 804.

A value of a message type of each of the new entries, which are added to the topology relation table 804, is equal to a value of each type that is stored in a message type field of the entry that is selected in step S205. In addition, the topology relation learning unit 711 issues IDs that respectively identify the new entries to the new entries.

In step S208, in each of the new entries that are added to the topology relation table 804, a value of the predictor ID is an ID of an entry selected in step S203 among the entries obtained from the failure predictor table 801 in step S201. A failure type in each of the new entries is a failure type that causes the topology relation learning unit 711 to start the process in FIG. 12. In addition, a path of each of the new entries is an XPath expression that is generated in step S207.

When one or more entries are added to the topology relation table 804 in step S208 as described above, the learning process in FIG. 12 returns to step S204 again.

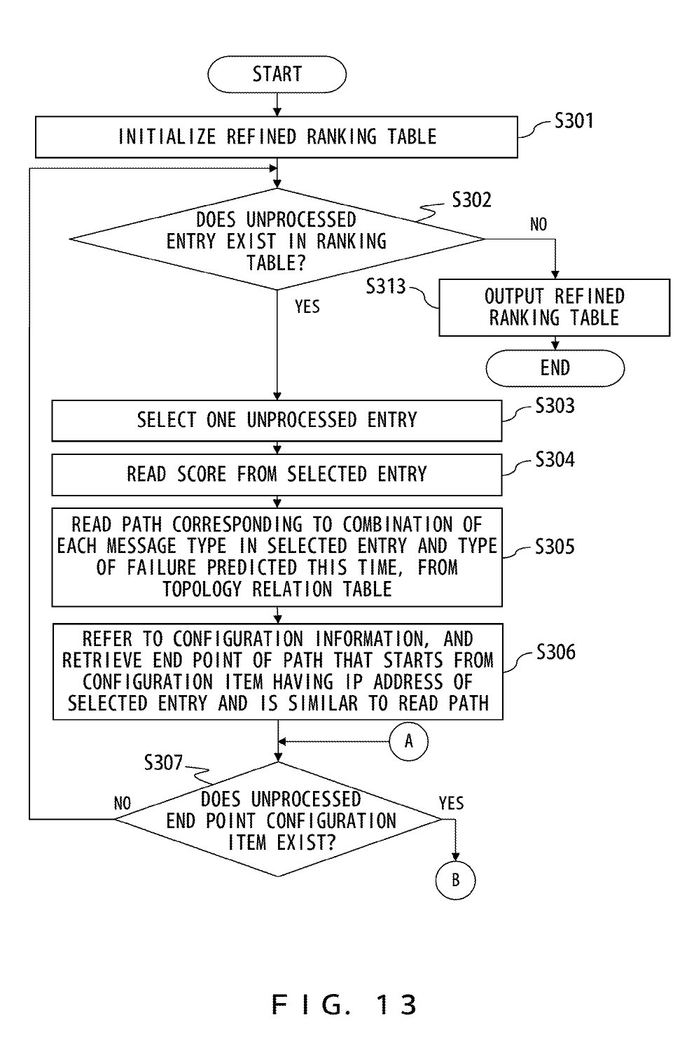

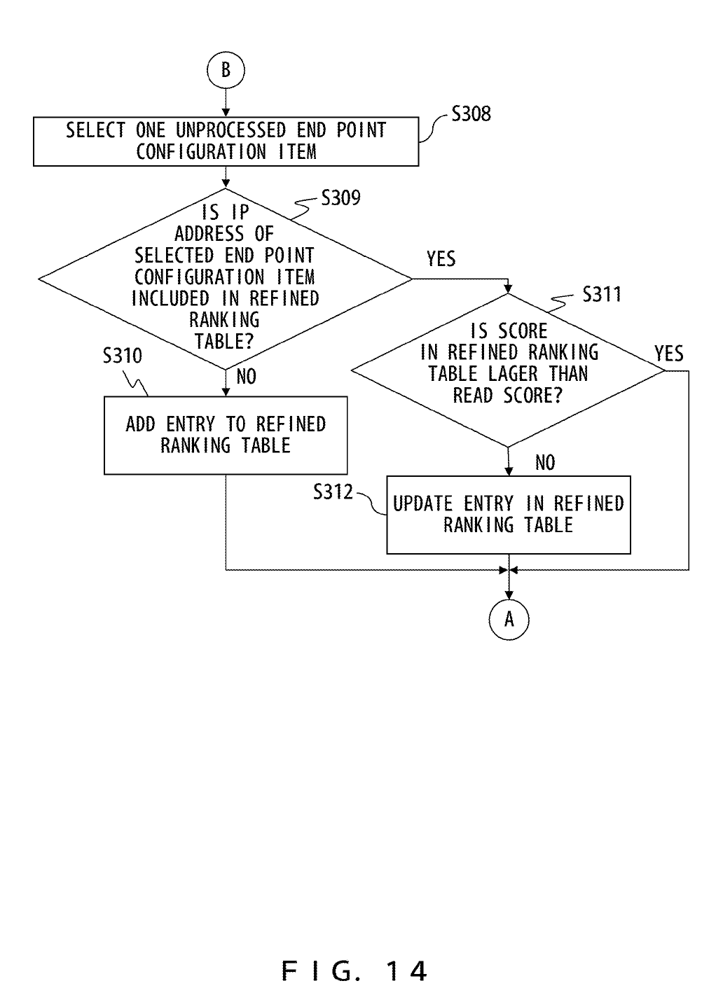

FIGS. 13-14 are flowcharts of a process in which the detection server 700 in the third embodiment (specifically, the estimation unit 714) generates the refined ranking information using the learnt relation information. As described above, the process in FIGS. 13-14 is performed when an occurrence of a type of failure is predicted according to a message pattern and relation information regarding a combination of the message pattern and the type of failure has been learnt.

In step S301, the estimation unit 714 initializes the refined ranking table 806 to empty.

Although FIG. 11 was not described in detail, the third embodiment was described by using the term “a refined ranking table” in common with the following two tables.
A table that the estimation unit 714 generates locally in response to a prediction
A table in the ranking information storage unit 710, in which each entry in the table generated by the estimation unit 714 is stored

Namely, in an aspect, the refined ranking table 806 in FIG. 11 is a table having two entries which the estimation unit 714 locally generates corresponding to one prediction illustrated in FIG. 9. On the other hand, in another aspect, the refined ranking table 806 in FIG. 11 illustrates only two entries that are extracted from a table in the ranking information storage unit 710, which stores the refined ranking information.

For simplicity of description, both of the tables are referred to simply as a “refined ranking table 806” in the present specification. Similarly, both a table that is locally generated by the ranking generation unit 709 and a table that is stored in the ranking information storage unit 710 are commonly referred to as a “ranking table 805” in the present specification.

The refined ranking table 806 in the descriptions of FIGS. 13-14 is more specifically the table that is locally generated by the estimation unit 714. Accordingly, in step S301, the local table is initialized.

Next, in step S302, the estimation unit 714 judges whether there is an unprocessed entry in the ranking table 805, which is output by the ranking generation unit 709. When the processes of steps S303-S312 are finished with respect to all of the entries in the ranking table 805, the estimation unit 714 next performs the process of step S313. In contrast, when there remains an unprocessed entry in the ranking table 805, the estimation unit 714 next performs the process of step S313.

In step S303, the estimation unit 714 selects one unprocessed entry in the ranking table 805 which is output by the ranking generation unit 709. Hereinafter, the entry selected in step S303 is also referred to a “selected entry” for convenience.

Next, in step S304, the estimation unit 714 reads a score (i.e., WF-IDF(f, n), which is calculated with respect to a configuration item of the selected entry) from the selected entry.

In step S305, the estimation unit 714 reads a path corresponding to a combination of each message type in the selected entry and the type of a failure that is predicted by the failure predictor detection unit 702 in this case, from the topology relation table 804. More specifically, a list of one or more types is stored in a message type field in the selected entry. Therefore, the estimation unit 714 retrieves an entry that satisfies all of the following three conditions from the topology relation table 804, with respect to each type in the list, and reads a path from the retrieved entry.
A predictive pattern in an entry in the failure predictor table 801, which is identified by a value in a predictor ID field, is equal to a predictive pattern that the failure predictor detection unit 702 detects in this case (in other words, the latter predictive pattern is a predictive pattern that is stored in the entry in the failure predictor table 801, which is identified by a value in the predictor ID field in the ranking table 805, which the estimation unit 714 receives from the ranking generation unit 709).
A value in the failure type field is equal to the type of the failure that the failure predictor detection unit 702 predicts in this case (i.e., a type that is reported to the estimation unit 714 by the ranking generation unit 709)
A value in the message type field is equal to one of the values in the list of the message type field in the selected entry

The number of paths that are read in step S305 may be one or plural. For example, when the selected entry is a second entry in the ranking table 805 in FIG. 11, in step S305, a path of a second entry in the topology relation table 804 in FIG. 11 (i.e., an XPath expression representing a path P2 in FIG. 8) is obtained. For example, when a specific type of failure according to a specific message pattern has been predicted correctly two or more times in the past, two or more paths may be obtained in step S305 in some cases. Also when two or more types are recorded in the message type field of the selected entry, two or more paths may be obtained in step S305 in some cases.

Next, in step S306, the estimation unit 714 refers to configuration information stored in the configuration information storage unit 712, and retrieves a configuration item at an endpoint of a path that starts from a configuration item having an IP address of the selected entry and is similar to a path that is read in step S305. Hereinafter, for convenience of description, the retrieved configuration item is referred to as an “end point configuration item”. As described with respect to FIG. 9, in step S306, only a configuration item at an end point of a path that satisfies shortest path conditions is retrieved.

As described above, each configuration item in the configuration information is identified by an IP address. Accordingly, the estimation unit 714 can also obtain an IP address of the end point configuration item as a result of retrieval.

For example, when the selected entry is a first entry in the ranking table 805 in FIG. 11, in step S305, a path of a first entry in the topology relation table 804 (i.e., an XPath expression representing a path P1 in FIG. 8) is obtained. The IP address of the selected entry is the IP address E. Accordingly, the estimation unit 714 traverses a path P11 that starts from a configuration item having the IP address E and is similar to the path P1. Then, a configuration item represented by a node N24 (i.e., a configuration item that is identified by the IP address D) is found as an end point configuration item.

When the selected entry is a second entry in the ranking table 805 in FIG. 11, two end point configuration items are found, as can be seen from the descriptions related to FIG. 9. Namely, two configuration items which are represented by nodes N24 and N25 are found. Similarly, also when the selected entry is a third entry in the ranking table 805 in FIG. 11, the two configuration items which are represented by the nodes N24 and N25 are found as an endpoint configuration item.

As described above, in step S306, one end point configuration item may be found, or a plurality of end point configuration items may be found. However, in some cases, no end point configuration items may be found in step S306.

When two or more paths are read in step S305, an endpoint configuration item is retrieved for each of the paths in step S306. As a result, a plurality of end point configuration items may be obtained, or end point configuration items which are obtained for the two or more paths may coincidentally be the same as each other.

In step S307, the estimation unit 714 judges whether there is an unprocessed end point configuration item. When no end point configuration items are found in step S306 or the processes of steps S308-S312 are finished with respect to all of the end point configuration items that are found in step S306, the estimation unit 714 performs the judgment of step S302 again.

In contrast, when one or more end point configuration items are found in step S306 and there remains endpoint configuration items that are not selected as a target of the processes of steps S308-S312, then the estimation unit 714 selects one of the unselected end point configuration items in step S308. Hereinafter, for convenience of description, the endpoint configuration item selected in step S308 is referred to as a “selected end point configuration item”.

Next, in step S309, the estimation unit 714 judges whether an IP address of the selected endpoint configuration item is included in the refined ranking table 806.

For example, when the selected configuration item is a configuration item represented by the node N24 in FIG. 9 (i.e., a configuration item identified by the IP address D), the estimation unit 714 retrieves the refined ranking table 806 using the IP address D as a retrieval key. As a result of retrieval, when an entry is found, the estimation unit 714 judges that the IP address of the selected end point configuration item is included in the refined ranking table 806. In contrast, when no entries are found, the estimation unit 714 judges that the IP address of the selected end point configuration item is not included in the refined ranking table 806.

When the IP address of the selected end point configuration item is not included in the refined ranking table 806, then the estimation unit 714 performs the process of step S310. In contrast, when the IP address of the selected end point configuration item is included in the refined ranking table 806, then the estimation unit 714 performs the process of step S311.

In step S310, the estimation unit 714 adds a new entry including the following four values to the refined ranking table 806.
A predictor ID value common to all entries in the ranking table 805 that the estimation unit 714 receives from the ranking generation unit 709. This predictor ID value is equal to an ID that is used when the failure predictor detection unit 702 stores a result of a prediction that causes the estimation unit 714 to start the process in FIGS. 13-14 in the failure predictor information storage unit 704.
An IP address that identifies the selected end point configuration item
In a case in which only one path is used for the retrieval in step S306 of the currently selected endpoint configuration item with respect to one configuration item having an IP address of a selected entry, a message type that is used as a retrieval key when the one path is read in step S305. In a case in which two or more paths are used for the retrieval in step S306 of the currently selected endpoint configuration item, a list of message types that are respectively used as a retrieval key when the two or more paths are read in step S305.
A score that is read from the selected entry in the ranking table 805 in step S304

In a new entry added in step S310, a ranking field is empty. After the addition of the entry, the estimation unit 714 performs the judgment of step S307 again.

On the other hand, step S311 is performed, for example, when the same configuration item is respectively found coincidentally as endpoints of paths that respectively start from two or more configuration items corresponding to two or more entries in the ranking table 805. For example, in the example in FIG. 9, an end point of a path P11, an end point of a path P12, and an end point of a path P13 are respectively the node N24. Accordingly, an entry on a configuration item represented by the node N24 (i.e., a configuration item identified by the IP address D) is found twice as a result of the retrieval in step S309.

Specifically, in step S311, the estimation unit 714 judges whether a score in the refined ranking table 806 is larger than a score that is read from the selected entry in the ranking table 805 in step S304. Here, the “score in the refined ranking table 806” is, specifically, a score in an entry that is found as a result of the retrieval of the refined ranking table 806 in step S309.

When the score in the refined ranking table 806 is larger than the score that is read from the selected entry in step S304, the entry that is found in the retrieval in step S309 does not need to be updated. In this case, the estimation unit 714 next performs the judgment of step S307.

In contrast, when the score in the refined ranking table 806 does not exceed the score that is read from the selected entry in step S304, then the estimation unit 714 updates an entry in the refined ranking table 806 in step S312. Namely, the estimation unit 714 updates the entry that is found as a result of the retrieval of the refined ranking table 806 in step S309. The details are as described below.

When the score in the refined ranking table 806 is smaller than the score that is read in step S304, the estimation unit 714 replaces a value in a score field with the score that is read in step S304. In this case, the estimation unit 714 also replaces a message type field with the following contents.
In a case in which only one path is used for retrieving the currently selected end point configuration item in step S306 with respect to one configuration item having an IP address of the selected entry, a message type that is used as a retrieval key when the one path is read in step S305.
In a case in which two or more paths are used for retrieving the currently selected end point configuration item in step S306, a list of message types that are respectively used as a retrieval key when the two or more paths are read in step S305.

On the other hand, when the score in the refined ranking table 806 is equal to the score that is read in step S304, the estimation unit 714 does not update a score field but adds the following contents to the list in the message type field.
In a case in which only one path is used for retrieving the currently selected end point configuration item in step S306 with respect to one configuration item having an IP address of the selected entry, a message type that is used as a retrieval key when the one path is read in step S305.
In a case in which two or more paths are used for retrieving the currently selected end point configuration item in step S306, message types that are respectively used as a retrieval key when the two or more paths are read in step S305.

After the update as described above, the estimation unit 714 performs the judgment of step S307. According to steps S309-S312, information according to relation with a sender of which type of message a score is provided to the endpoint configuration item is indicated in the message type field in the refined ranking table 806.

When all of the entries in the ranking table 805, which the estimation unit 714 receives from the ranking generation unit 709, have already been selected, the process in FIGS. 13-14 proceeds from step S302 to step S313.

In step S313, the estimation unit 714 sorts entries in the refined ranking table 806 in descending order of score. Then, the estimation unit 714 records a ranking according to the sorting result in each entry. In FIG. 11, the refined ranking table 806, which represents a result of the ranking described above, is illustrated.

In step S313, the estimation unit 714 further outputs the refined ranking table 806 as the estimation result information 730. For example, the estimation unit 714 may add each entry in the refined ranking table 806, which is generated locally as described above, to a table in the ranking information storage unit 710. The estimation unit 714 may output the refined ranking table 806 to the output device 105, such as a display, or may output the refined ranking table 806 to another device through the communication interface 103. The estimation unit 714 may transmit, for example, an electronic email, an instant message, or the like, including the refined ranking table 806.

After the output in step S313, the process in FIGS. 13-14 is finished. Then, the detection server 700 awaits an occurrence of an event in step S101 of FIG. 7 again.

In the third embodiment, which is described above with reference to FIGS. 8-14, more reliable refined ranking information in which relation information is considered is presented. In addition, in the third embodiment, a feature is used whereby a large-scale computer system often includes a plurality of portions having configurations similar to each other. By using this feature, a data sparseness problem in the learning regarding the large-scale computer system is also reduced.

The ranking information that is output as the estimation result information 430 in the second embodiment, which does not use the relation information, is also information with a sufficiently high reliability for practical use.

This is because, as a general tendency, a message of the type “n”, for which a large WF-IDF(f, n) value is calculated with respect to a failure #f, is likely to have direct or indirect relation of cause and effect with the failure #f rather than coincidentally co-occur with the failure #f. Empirically, a sender of the message of the type “n”, which is closely related to the failure #f as described above, tends to be a configuration item in which the failure #f occurs comparatively frequently.

Accordingly, in many cases, it is useful to take some measures against a configuration item of a sender of a message of the type “n”, for which a large WF-IDF(f, n) value is calculated, in order to prevent an occurrence of a failure #f. Therefore, sufficiently highly reliable and useful ranking information for practical use is obtained even without using the relation information as in the second embodiment.

In a sender of one of the messages included in a message pattern that is detected as a predictor of a type of failure, a failure of a type that is predicted from the message pattern may occur coincidentally.

For example, in the example in FIG. 8, assume that a message M22 is output from a configuration item that is identified by an IP address “Y”, not a configuration item that is identified by an IP address “Z”. In this case, a sender of the message M22 that is included in a message pattern 601, which is detected as a predictor of a failure #39, is coincidentally the same as a configuration item in which the predicted failure #39 occurs. Accordingly, a path that is learnt regarding the message M22 in this case is a shortest path from a configuration item that is identified by an IP address “Y” to the same configuration item that is identified by the IP address “Y”. Namely, in this case, an empty path is learnt with respect to the message M22. An empty path, which starts at a configuration item and ends at the same configuration item, may be represented by a specific string for representing the empty path (a string that is not an empty string).

When an empty path is learnt as relation information and the empty path is read in step S305 of FIG. 13, an end point configuration item that is found in step S306 is a configuration item that is a start point of the path (i.e., a configuration item that is identified by an IP address of a selected entry).

The present invention is not limited to the first to third embodiments, and the first to third embodiments may be varied in various ways. Some aspects of a variation of the first to third embodiments are described below as an example. The variations described below can be optionally combined without causing any mutual contradiction.

Various tables are illustrated in FIG. 6 and FIG. 11, but formats of various pieces of information are optional according to an embodiment. A data format other than a table may be used, or a table that further includes fields that are not illustrated may be used.

Further, a statistic other than WF-IDF(f, n) in the expression (1) may be used. Various variations of WF-IDF(f, n) are as described above.

The ranking table 507 is described as an example of the estimation result information 430, and the refined ranking table 806 is described as an example of the estimation result information 730. However, a format of the estimation result information may vary according to an embodiment.

For example, only pieces of identification information of configuration items having U highest ranks may be output as the estimation result information (1≦U). In addition, it is sufficient that at least one of a ranking and a score (i.e., WF-IDF (f, n)) is associated with identification information of a configuration item and is included in the estimation result information. Namely, both the ranking and the score are not always needed. In the estimation result information, a message type can be omitted. Of course, information including both the ranking table 805 and the refined ranking table 806 may be output as the estimation result information 730.

As is also described with respect to the first embodiment, a granularity of a configuration item to be evaluated with a value such as WF-IDF (f, n) may vary according to an embodiment. For example, an embodiment in which a guest OS and an application are treated as different configuration items is possible, and an embodiment in which a set of a guest OS and an application that runs on the guest OS is treated as one configuration item is possible. Identification information that identifies each configuration item may be optional information according to the granularity of the configuration item.

In the descriptions of the second and third embodiments, a message reporting a failure occurrence and messages reporting the other events are distinguished. However, in some embodiments, the failure predictor detection unit 402 or 702 may predict an occurrence of another type of failure (for example, a serious failure) from a message pattern including a message reporting an occurrence of a certain type of failure (for example, a minor failure).

For example, when the second embodiment is varied as described above, the log statistics calculation unit 405 may update the log statistics table 505 similarly to step S102 without depending on whether a received message 420 is reporting a failure occurrence or another event. When the received message 420 is reporting the failure occurrence, the predictive statistics calculation unit 407 further performs the process of step S103. In this case, step S103 may be performed prior to step S102. The third embodiment may be varied similarly.

In the generation of ranking information in the second and third embodiments, a process of adopting a maximum value from among some values as illustrated in steps S109-S112 in FIG. 7 is performed in some cases. Similarly, in the generation of refined ranking information in the third embodiment, a process of adopting a maximum value from among some values as illustrated in steps S309-S312 in FIG. 14 is performed in some cases.

However, in some embodiments, a process of adopting an arithmetic sum or a weighted sum of some values may be performed instead of the process of adopting a maximum value among some values. For example, in the example in FIG. 9, the estimation unit 714 may provide an arithmetic sum or a weighted sum of three values of WF-IDF(39, 1), WF-IDF(39, 2), and WF-IDS(39, 3) instead of a maximum value among the three values.

In the descriptions above, it is assumed that, when a failure occurs in a configuration item, the configuration item transmits a message reporting a failure occurrence.

However, in some embodiments, when a failure occurs in a configuration item, another configuration item may output a message reporting a failure occurrence in the former configuration item. For example, the latter configuration item may monitor whether a failure has occurred in the former configuration item and output a message in reply to the failure occurrence in the former configuration item.

For example, in the example in FIG. 8, when a failure occurs at the time t24 in a configuration item that is identified by an IP address “Y”, a configuration item that is identified by another IP address (for convenience, “Y2”) may output a message similar to a message M24. Assume that the output message includes the IP address “Y”, which identifies the configuration item in which the failure occurs. The type of the message that is output from the configuration item that is identified by the IP address “Y2” as described above is also classified as “39”.

In this case, note that the topology relation learning unit 711 does not learn relation between a sender of each message included in a predictive pattern and the configuration item that is identified by the IP address “Y2”. Namely, also in this case, the topology relation learning unit 711 learns relation between a sender of each message in a predictive pattern and the configuration item that is identified by the IP address “Y”.

Of course, as described with respect to the first embodiment, the IP address is merely an example of identification information. In some embodiments, identification information other than the IP address may be used.

The detection server 400 may include at least the ranking generation unit 409 among components in FIG. 5. The other components may be implemented on another computer that can communicate with the detection server 400. For example, when the failure predictor detection unit 402 is implemented on another computer, the detection server 400 may recognize a prediction of a failure by receiving a prediction notification as described with respect to step S1 of FIG. 1.

Similarly, the detection server 700 only needs to include at least the ranking generation unit 709 and the estimation unit 714 among components in FIG. 10. For example, when the topology relation learning unit 711 is implemented on another computer, the estimation unit 714 of the detection server 700 only needs to refer to relation information learnt by the topology relation learning unit 711 of the other computer.

The detection servers 400 and 700 are specific examples of a detection device having the following components.
Predictor detection means that predicts a failure occurrence or receives a prediction notification similarly to step S1 of FIG. 1
Calculation means that calculates a statistic similarly to step S2 of FIG. 1
Generation means that generates result information similarly to step S3 of FIG. 1
Output means that outputs the result information similarly to step S4 of FIG. 1

For example, the failure predictor detection units 402 and 702 are examples of predictor detection means that predict a failure occurrence, and are realized by the CPU 101. An example of predictor detection means that receives a prediction notification is a combination of the communication interface 103 and the CPU 101.

The ranking generation unit 409 of the detection server 400 is an example of the calculation means, and is also an example of the generation means. The ranking generation unit 709 of the detection server 700 is an example of the calculation means, and the estimation unit 714 of the detection server 700 is an example of the generation means. According to an aspect, the log statistics calculation units 405 and 705 and the predictive statistics calculation units 407 and 707 generate information used for the calculation of WF-IDF(f, n), and therefore, they are considered to realize a portion of the calculation means. In any case, the calculation means may be realized by, for example, the CPU 101.

An example of the output means is the output device 105, the communication interface 103, or the like.

As described above, in the third embodiment, the process in FIG. 12 is performed when some kind of failure actually occurs. However, in some embodiments, the detection server 700 may learn relation information by a batch process similar to the process in FIG. 12.

For example, assume that the log information storage unit 701 includes entries on α failures that have actually occurred so far and that the failure predictor information storage unit 704 includes entries on β correct predictor detections by the failure predictor detection unit 702 with respect to the α failures. Among the α failures, some failures are not predicted correctly, some failures are predicted correctly only once, and some failures are predicted correctly two or more times. Therefore, any of α<β, α>β, and α=β is possible.

In any case, the topology relation learning unit 711 may perform a batch process that is similar to the process in FIG. 12, instead of performing the process in FIG. 12, every time one failure occurs. Namely, by performing the batch process once, the topology relation learning unit 711 may learn relation information regarding each of the α failures (i.e., a plurality of failures in the past, whose occurrence has been recorded in the log information storage unit 701).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A detection method executed by a computer, the detection method comprising:
calculating, by the computer, a statistic for each of Q configuration items, where Q is at least one, among a plurality of configuration items, according to a first frequency and a second frequency, when an occurrence of a failure of a certain type is predicted according to a first pattern, which is a combination of P messages output from the Q configuration items within a period not longer than a predetermined length of time, where P is not less than Q, wherein
the statistic relates to a probability that the failure of a certain type will occur in the individual configuration item in a future,
each of the plurality of configuration items is hardware, software, or a combination thereof included in a computer system,
the first frequency indicates how many times a message of a same type as a type of an output message that is included in the P messages and that has been output from the individual configuration item has been output before a point in time of occurrence at which the failure of a certain type has formerly occurred, and
the second frequency indicates how many times the message of the same type as the type of the output message has been output within a window of time that extends for the predetermined length of time and ends at a point in time of output, at which a message has been output before the point in time of occurrence, and how many times an occurrence of the failure of a certain type has been predicted according to a second pattern, which is a combination of one or more messages included in the window period; and
generating result information by the computer according to the statistic, the result information indicating at least one configuration item in which the failure of a certain type is predicted to occur with a probability that is at least higher than a probability with which the failure of a certain type is predicted to occur in another of the plurality of configuration items.

2. The detection method according to claim 1, wherein
the statistic monotonously decreases relative to the first frequency, and monotonously increases relative to the second frequency.

3. The detection method according to claim 1, wherein
the result information includes identification information that identifies a configuration item having a maximum value of the statistic among the Q configuration items.

4. The detection method according to claim 1, wherein
the generating result information comprises:
retrieving, for each of the P messages, a relevant configuration item from among the plurality of configuration items by using configuration information indicating relation between the plurality of configuration items,
the relevant configuration item satisfying, with a configuration item that has output the message included in the P messages, second relation that is equivalent to first relation between a first configuration item that has output a message that has a type equal to the type of the message included in the p messages and is included in the second pattern used for the prediction in which the occurrence of the failure of a certain type has been correctly predicted formerly, and a second configuration item in which the failure of a certain type, which has been correctly predicted formerly, has actually occurred;
when the relevant configuration item is found for a configuration item included in the Q configuration items, determining an evaluation value regarding a probability that the failure of a certain type will occur in a future in the relevant configuration item, according to the statistic calculated for the configuration item included in the Q configuration items; and
generating the result information according to the evaluation value, which is determined for the respective configuration items that have been found as a result of retrieval.

5. The detection method according to claim 4, wherein
the result information includes identification information that identifies a configuration item having a maximum value of the evaluation value among at least one configuration item that has been found as the relevant configuration item regarding at least one of the Q configuration items.

6. The detection method according to claim 4, wherein
the relation indicated by the configuration information is:
logical dependency between two configuration items;
physical connection relation between two configuration items;
a composition of at least two logical dependencies;
a composition of at least two physical connection relation, or
a composition of the at least one logical dependency and the at least one physical connection relation.

7. The detection method according to claim 1, further comprising:
updating, by a computer, a count value that is stored in a storage device while being associating with a type of a message, every time the message is output from one of the plurality of configuration items; and
calculating, by the computer, the first frequency from the count value.

8. The detection method according to claim 1, further comprising:
every time a failure of one type among a plurality of types actually occurs, updating, by the computer, a count value that is stored in a storage device while being associated with a combination of a type of each message included in the second pattern that is the basis for a correct prediction of the failure and the one type of the failure; and
calculating, by the computer, the second frequency from the count value.

9. A non-transitory computer-readable recording medium having stored therein a detection program for causing a computer to execute a process comprising:
calculating a statistic for each of Q configuration items, where Q is at least one, among a plurality of configuration items, according to a first frequency and a second frequency, when an occurrence of a failure of a certain type is predicted according to a first pattern, which is a combination of P messages output from the Q configuration items within a period not longer than a predetermined length of time, where P is not less than Q, wherein
the statistic relates to a probability that the failure of a certain type will occur in the individual configuration item in a future,
each of the plurality of configuration items is hardware, software, or a combination thereof included in a computer system managed by the computer,
the first frequency indicates how many times a message of a same type as a type of an output message that is included in the P messages and that has been output from the individual configuration item has been output before a point in time of occurrence at which the failure of a certain type has formerly occurred, and
the second frequency indicates how many times the message of the same type as the type of the output message has been output within a window of time that extends for the predetermined length of time and ends at a point in time of output, at which a message has been output before the point in time of occurrence, and how many times an occurrence of the failure of a certain type has been predicted according to a second pattern, which is a combination of one or more messages included in the window period; and
generating result information according to the statistic, the result information indicating at least one configuration item in which the failure of a certain type is predicted to occur with a probability that is at least higher than a probability with which the failure of a certain type is predicted to occur in another of the plurality of configuration items.

10. A detection device comprising:
a processor configured to perform a process including:
calculating a statistic for each of Q configuration items, where Q is at least one, among a plurality of configuration items, according to a first frequency and a second frequency, when an occurrence of a failure of a certain type is predicted according to a first pattern, which is a combination of P messages output from the Q configuration items within a period not longer than a predetermined length of time, where P is not less than Q, wherein
the statistic relates to a probability that the failure of a certain type will occur in the individual configuration item in a future,
each of the plurality of configuration items is hardware, software, or a combination thereof included in a computer system managed by the computer,
the first frequency indicates how many times a message of a same type as a type of an output message that is included in the P messages and that has been output from the individual configuration item has been output before a point in time of occurrence at which the failure of a certain type has formerly occurred, and
the second frequency indicates how many times the message of the same type as the type of the output message has been output within a window of time that extends for the predetermined length of time and ends at a point in time of output, at which a message has been output before the point in time of occurrence, and how many times an occurrence of the failure of a certain type has been predicted according to a second pattern, which is a combination of one or more messages included in the window period; and
generating result information according to the statistic, the result information indicating at least one configuration item in which the failure of a certain type is predicted to occur with a probability that is at least higher than a probability with which the failure of a certain type is predicted to occur in another of the plurality of configuration items.
